(19) United States
(12) Patent Application Publication
(10) Pub. No.: US 2019/0273986 A1
(43) Pub. Date: Sep. 5, 2019

(54) GUN MICROPHONE WIND SHIELD

(71) Applicant: TOMOEGAWA CO., LTD., Tokyo (JP)

(72) Inventors: Fukushi KAWAKAMI, Hamamatsu-shi, Shizuoka (JP); Takayuki SANO, Shizuoka-shi, Shizuoka (JP)

(21) Appl. No.: 16/088,416

(22) PCT Filed: Feb. 14, 2017
(86) PCT No.: PCT/JP2017/005381

§ 371 Date: Sep. 25, 2018

(30) Foreign Application Priority Data
Mar. 29, 2016 (JP) 2016-065176

(51) Int. Cl. H04R 1/32; H04R 1/08

(52) U.S. Cl. CPC H04R 1/326; H04R 1/08

(57) ABSTRACT

There is provided a gun microphone that can shut off properly wind noise such as whistling sounds while a gun microphone is used.

The gun microphone wind shield includes a second covering body that defines a first space between the second covering body and a first covering body and a third covering body that defines a second space between the third covering body and the second covering body, and forms a second longitudinal flow path that moves the air having flowed into the second space along the longitudinal direction of the second covering body and a first longitudinal flow path that moves the air having flowed into the first space along the longitudinal direction of the first covering body.

### TECHNICAL FIELD

The present invention relates to a wind shield used for a gun microphone with directivity.

### BACKGROUND ART

Gun microphones (shot-gun microphones) are used in many cases to pick up sounds at a long distance. The gun microphone has high directivity and can pick up sounds ahead of the gun microphone while canceling out surrounding sounds.

In general, the gun microphone has a narrow and elongated columnar interference tube. The gun microphone can pick up mainly sounds ahead of the gun microphone by interfering with sounds emitted from a sound source positioned on the lateral sides of the gun microphone to cancel out the sounds in the interference tube.

As described above, the gun microphone has an elongated interference tube. Accordingly, when wind noise such as whistling sounds is picked up by the gun microphone, the entire gun microphone including the interference tube needs to be covered with a wind shield.

As one of conventional wind shields, there is a wind shield in which an almost cylindrical sponge has fibers implanted in the internal diameter side. This wind shield is designed to be hard to come off an elongated microphone due to the implanted fibers (for example, refer to Patent Literature 1).

There is also a wind shield with a cage-shaped frame. The cage-shaped frame forms a space from an elongated microphone and supports the wind shield (for example, refer to Patent Literature 2).

Further, there is a wind shield that is made from an elastic body with open cells and has a slide guide member on the inner peripheral surface of the elastic body. The provision of the slide guide member is intended to enhance the ease of attachment to and detachment from an elongated microphone (for example, refer to Patent Literature 3).

### CITATION LIST

### Patent Literatures

### Patent Literature 1: JP 2006-60479 A

### Patent Literature 2: JP 2012-175379 A

### Patent Literature 3: JP 2008-187312 A

### SUMMARY OF INVENTION

### Technical Problem

As described above, various wind shields have been devised. However, a wind shield made from an elastic body with open cells such as sponge can initially decrease wind noise but suffers from gradual aged deterioration due to moisture from rain or the like. As the results, the wind shield is difficult to maintain its characteristics.

The present invention is devised in light of the foregoing problem. An object of the present invention is to provide a gun microphone wind shield that is attachable to an elongated gun microphone and can properly shut off wind noise such as whistling sounds when being attached to a gun microphone.

### Solution to Problem

An aspect of a gun microphone wind shield according to the present invention includes: a first covering body that covers a gun microphone, has an elongated shape, and contains an acoustic transmissive material; a second covering body that covers the first covering body, is arranged in a position separated from the first covering body, has an elongated shape, contains an acoustic transmissive material, and defines a first space between the second covering body and the first covering body; a third covering body that covers the second covering body, is arranged in a position separated from the second covering body, has an elongated shape, contains an acoustic transmissive material, and defines a second space between the third covering body and the second covering body, wherein the acoustic transmissive material contains a fiber material obtained by interlacing a raw material containing fibers, blocks part of air in contact, and transmits the remainder of the air, wherein the second space has a second longitudinal flow path in which air having flowed into the second space moves along a longitudinal direction of the second covering body, and the first space has a first longitudinal flow path in which air having flowed into the first space moves along a longitudinal direction of the first covering body.

The acoustic transmissive material contains a fiber material obtained by interlacing a raw material containing fibers, which prevents or reduces aged deterioration over a long period of time.

The second space has the second longitudinal flow path in which the air having flowed into the second space moves along the longitudinal direction of the second covering body. Accordingly, the air having flowed into the second space moves in the longitudinal direction, which makes the air less likely to leak from the second space to the first space.

The first space has the first longitudinal flow path in which the air having flowed into the first space moves along the longitudinal direction of the first covering body. Accordingly, the air having flowed into the first space moves in the longitudinal direction, which makes the air less likely to leak from the first space to the gun microphone and shut off properly whistling sounds.

### Advantageous Effects of Invention

The gun microphone wind shield according to the present invention can shut off properly whistling sounds even when being used for a long period of time.

### BRIEF DESCRIPTION OF DRAWINGS

FIG. 1 is a diagram schematically illustrating a gun microphone wind shield 100 according to an embodiment. FIG. 1A is a cross-sectional view of the gun microphone wind shield 100, FIG. 1B is a cross-sectional view of flows of air moving along a longitudinal direction of the gun microphone wind shield 100, and FIG. 1C is a cross-sectional view of flows of air moving along a circumferential direction of the gun microphone wind shield 100.

FIG. 2 is a perspective view of the entire gun microphone wind shield 100.

FIG. 3 is a perspective view of a first acoustic transmissive body 110, a second acoustic transmissive body 120, a third acoustic transmissive body 130, an elastic foaming body 140, a basket 150, and a gun microphone 300 stored in the gun microphone wind shield 100.

FIG. 4 is a cross-sectional view of a configuration of the gun microphone wind shield 100 taken along the circumferential direction.

FIG. 5 is a cross-sectional view of the gun microphone wind shield 100 taken along the longitudinal direction.

FIG. 6 is a cross-sectional view (FIG. 6A) of longitudinal flows of air and is a cross-sectional view (FIG. 6B) of circumferential flows of air in a first space SP10 and a second space SP20.

FIG. 7 is a perspective view of a first acoustic transmissive body 110, a second acoustic transmissive body 120, a third acoustic transmissive body 130, a basket 150, and a gun microphone 300 stored in a gun microphone wind shield 200.

FIG. 8 is a cross-sectional view of the gun microphone wind shield 200 taken along the circumferential direction.

FIG. 9 is a cross-sectional view of the gun microphone wind shield 200 taken along the longitudinal direction.

FIG. 10 is a diagram schematically illustrating a component LP10 moving along the longitudinal direction and a component AP10 moving along the circumferential direction in the first acoustic transmissive body 110 and a component LP20 moving along the longitudinal direction and a component AP20 moving along the circumferential direction in the second acoustic transmissive body 120.

FIG. 11 is a side view of the basket 150 and a grip vibration-proof structure 400.

FIG. 12 is a perspective view of the basket 150 and the grip vibration-proof structure 400.

FIG. 13 is an enlarged side view of a structure of a grip portion 410.

FIG. 14 is a perspective view of the entire grip vibration-proof structure 400.

FIG. 15 is a front view of a state in which the first acoustic transmissive body 110 and the second acoustic transmissive body 120 are attached to an elastic hold body 434.

FIG. 16 is a perspective view of a state in which the first acoustic transmissive body 110 is attached to the elastic hold body 434.

FIG. 17 is a perspective view of an end of the basket 150.

### DESCRIPTION OF EMBODIMENTS

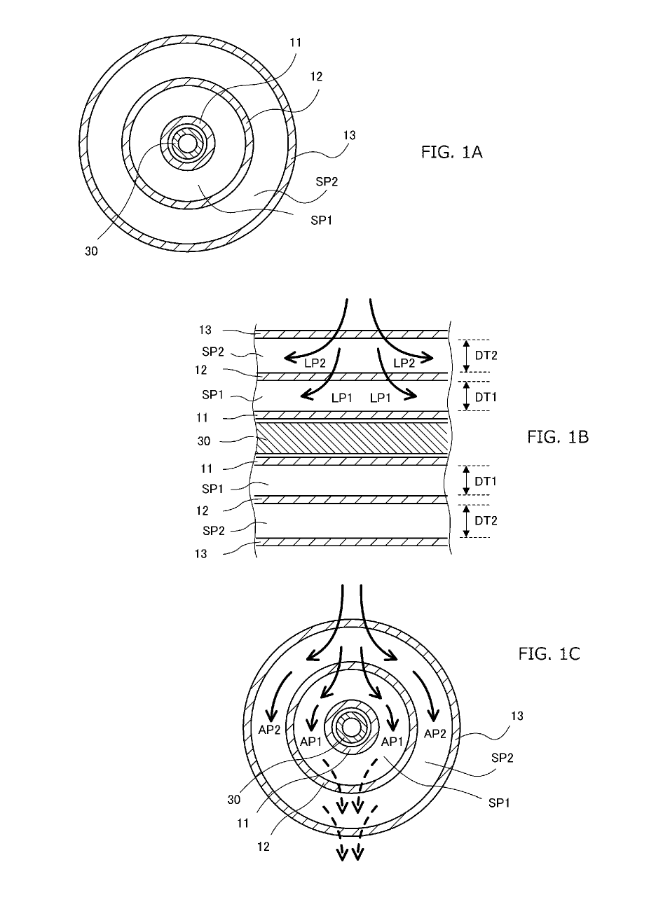

Embodiments will be described below with reference to the drawings. FIG. 1 is a diagram schematically illustrating a first aspect of the present invention. FIG. 1A is a cross-sectional view of the gun microphone wind shield 100, FIG. 1B is a cross-sectional view of flows of air moving along a longitudinal direction of the gun microphone wind shield 100, and FIG. 1C is a cross-sectional view of flows of air moving along a circumferential direction of the gun microphone wind shield 100.

### First Aspect

According to a first aspect of the present invention, as illustrated in FIGS. 1A, 1B, and 1C, there is provided a gun microphone wind shield 10 including: a first covering body 11 (for example, a first acoustic transmissive body 110 described later or the like) that covers a gun microphone 30 (for example, a gun microphone 300 as described later or the like), has an elongated shape, and contains an acoustic transmissive material; a second covering body 12 (for example, a second acoustic transmissive body 120 described later or the like) that covers the first covering body 11, is arranged in a position separated from the first covering body 11, has an elongated shape, contains an acoustic transmissive material, and defines a first space SP1 (for example, a first space SP10 described later or the like) between the second covering body 12 and the first covering body 11; a third covering body 13 (for example, a third acoustic transmissive body 130 described later or the like) that covers the second covering body 12, is arranged in a position separated from the second covering body 12, has an elongated shape, contains an acoustic transmissive material, and defines a second space SP2 (for example, a second space SP20 described later or the like) between the third covering body 13 and the second covering body 12, wherein the acoustic transmissive material contains a fiber material obtained by interlacing a raw material containing fibers, blocks part of air in contact, and transmits the remainder of the air, wherein the second space SP2 has a second longitudinal flow path LP2 (for example, a component LP20 moving along the longitudinal direction described later or the like) in which air having flowed into the second space SP2 moves along a longitudinal direction of the second covering body 12, and the first space SP1 has a first longitudinal flow path LP1 (for example, a component LP10 moving along the longitudinal direction described later or the like) in which air having flowed into the first space SP1 moves along a longitudinal direction of the first covering body 11.

### Gun Microphone Wind Shield 10 and Gun Microphone 30

The gun microphone wind shield 10 is a wind shield for covering the gun microphone 30. The gun microphone 30 is a microphone with directivity for picking up sounds emitted from a desired sound source. The gun microphone 30 has an interference tube or the like and is generally elongated in shape. The gun microphone wind shield 10 includes a first covering body 11, a second covering body 12, and a third covering body 13.

### Acoustic Transmissive Material

Each of the first covering body 11, the second covering body 12, and the third covering body 13 contains an acoustic transmissive material. The acoustic transmissive material includes a fiber material. The fiber material is obtained by interlacing a raw material containing fibers. The acoustic transmissive material blocks part of contacting air and transmits the remainder of the air.

The materials for the first covering body 11, the second covering body 12, and the third covering body 13 may be the same or different to one other. In addition, the same materials may be different in properties such as density and interlacing mode. The ingredients and substances of the acoustic transmissive material can be decided in such a manner as to shut off whistling sounds appropriately and pick up sounds emitted from a desired sound source.

Using the acoustic transmissive materials for the first covering body 11, the second covering body 12, and the third covering body 13 makes it possible to prevent or reduce aged deterioration over a long period of time.

### Outer Shapes of the First Covering Body 11, the Second Covering Body 12, and the Third Covering Body 13

The first covering body 11, the second covering body 12, and the third covering body 13 are elongated in shape. The shapes of the first covering body 11, the second covering body 12, and the third covering body 13 can be decided according to the elongated shape of the gun microphone 30.

The first covering body 11, the second covering body 12, and the third covering body 13 are desirably almost circular cylindrical in shape. Further, the first covering body 11, the second covering body 12, and the third covering body 13 are not limited to an almost circular cylindrical shape but may have any of various cylindrical shapes such as a square cylinder or an elliptic cylinder.

The longitudinal lengths of the first covering body 11, the second covering body 12, and the third covering body 13 are preferably the same. In this case, the longitudinal length of the first space SP1 and the longitudinal length of the second space SP2 described later become the same. This makes it possible to separate flows of air in the first space SP1 from flows of air in the second space SP2 to control individually the separate flows of air.

The longitudinal lengths of the first covering body 11, the second covering body 12, and the third covering body 13 may be different to one other. For example, when the longitudinal length of the second covering body 12 is shorter than the longitudinal lengths of the first covering body 11 and the third covering body 13, the boundary between the first space SP1 and the second space SP2 is absent in a region near the ends of the first covering body 11 and the third covering body 13, and a space without the second covering body 12 is formed between the first covering body 11 and the third covering body 13. In this case, the air in the first space SP1 and the second space SP2 can move directly via the space without the second covering body 12. In this way, when the longitudinal lengths of the first covering body 11, the second covering body 12, and the third covering body 13 are different, it is easy to move the air.

### First Covering Body 11

The first covering body 11 covers the gun microphone 30. The gun microphone 30 is generally elongated in shape and has an interferential opening along a longitudinal direction. The first covering body 11 needs to cover the gun microphone 30 in such a manner as to overlap at least part of the interferential opening. The first covering body 11 preferably covers the gun microphone 30 so as to overlap the entire interferential opening.

The longitudinal length of the first covering body 11 is preferably larger than the longitudinal length of the gun microphone 30. The first covering body 11 preferably covers the gun microphone 30 in such a manner as to store the entire gun microphone 30 except for a cable and the like connected to the gun microphone 30. Further, the first covering body 11 is desirably positioned to be concentric (coaxial) to the gun microphone 30 to cover the entire gun microphone 30.

### Second Covering Body 12

The second covering body 12 covers the first covering body 11. The second covering body 12 preferably stores the entire first covering body 11 and covers the first covering body 11. The second covering body 12 may be configured to cover part of the first covering body 11 as far as it can shut off whistling sounds.

The longitudinal length of the second covering body 12 is more preferably the same as the longitudinal length of the first covering body 11. The second covering body 12 is desirably positioned to be concentric (coaxial) to the first covering body 11 along the longitudinal direction of the first covering body 11 to store and cover the entire first covering body 11.

The second covering body 12 is arranged in a position separated from the first covering body 11. The first space SP1 is formed by the gap between the first covering body 11 and the second covering body 12. A distance DT1 between the first covering body 11 and the second covering body 12 may not be constant. The first space SP1 is formed between the first covering body 11 and the second covering body 12 to make the air less likely to leak to the inside of the first covering body 11, thereby shutting off whistling sounds. Arranging the second covering body 12 to be concentric (coaxial) to the first covering body 11 makes the distance DT1 constant. Making the distance DT1 constant between the first covering body 11 and the second covering body 12 allows the air having entered the first space SP1 to be dispersed evenly.

### Third Covering Body 13

The third covering body 13 covers the second covering body 12. The third covering body 13 preferably stores the entire second covering body 12 and covers the second covering body 12. The third covering body 13 may be configured to cover part of the second covering body 12 as far as it can shut off whistling sounds.

The longitudinal length of the third covering body 13 is more preferably the same as the longitudinal length of the second covering body 12. The third covering body 13 is desirably positioned to be concentric (coaxial) to the second covering body 12 along the longitudinal direction of the second covering body 12 to store and cover the entire second covering body 12.

The third covering body 13 is arranged in a position separated from the second covering body 12. The second space SP2 is formed by the gap between the second covering body 12 and the third covering body 13. A distance DT2 between the second covering body 12 and the third covering body 13 may not be constant. The second space SP2 is formed between the second covering body 12 and the third covering body 13 to make the air less likely to leak to the inside of the second covering body 12, thereby shutting off whistling sounds. Arranging the third covering body 13 to be concentric (coaxial) to the second covering body 12 makes the distance DT2 constant. Making the distance DT2 constant between the second covering body 12 and the third covering body 13 allows the air having entered the second space SP2 to be dispersed evenly.

### Second Longitudinal Flow Path LP2

As illustrated in FIG. 1B, a second longitudinal flow path LP2 is formed in the second space SP2. The second longitudinal flow path LP2 is a path in which the air having flowed into the second space SP2 moves along the longitudinal direction of the second covering body 12.

The second space SP2 is a space formed between the second covering body 12 and the third covering body 13. The second covering body 12 and the third covering body 13 have an elongated shape, and the second space SP2 also has an elongated shape. The second space SP2 acts as a region for facilitating the movement of the air in the longitudinal direction of the second space SP2. The air having flowed into the second space SP2 is guided by contact with the second covering body 12 and the third covering body 13 to move in the second space SP2 along the longitudinal direction. The path of the movement of the air constitutes the second longitudinal flow path LP2.

The second longitudinal flow path LP2 does not always need to extend along the longitudinal direction of the second space SP2 but includes at least a portion along the longitudinal direction. For example, the second longitudinal flow path LP2 may include a path toward to the second covering body 12, a path toward to the third covering body 13 or a path meandering through the second space SP2 as far as it includes a portion along the longitudinal direction.

The second longitudinal flow path LP2 may be short. The second longitudinal flow path LP2 does not need to reach the end of the second space SP2. The second longitudinal flow path LP2 includes at least a portion along the longitudinal direction of the second space SP2.

### First Longitudinal Flow Path LP1

As illustrated in FIG. 1B, a first longitudinal flow path LP1 is formed in the first space SP1. The first longitudinal flow path LP1 is a path in which the air having flowed into the first space SP1 moves along the longitudinal direction of the first covering body 11.

The first space SP1 is a space formed between the first covering body 11 and the second covering body 12. The first covering body 11 and the second covering body 12 have an elongated shape, and the first space SP1 also has an elongated shape. The first space SP1 acts as a region for facilitating the movement of the air in the longitudinal direction of the first space SP1. The air having flowed into the first space SP1 is guided by contact with the first covering body 11 and the second covering body 12 to move in the first space SP1 along the longitudinal direction. The path of the movement of the air constitutes the first longitudinal flow path LP1.

The first longitudinal flow path LP1 does not always need to extend along the longitudinal direction of the first space SP1 but includes at least a portion along the longitudinal direction. For example, the first longitudinal flow path LP1 may include a path toward to the first covering body 11, a path toward to the second covering body 12 or a path meandering through the first space SP1 as far as it includes a portion along the longitudinal direction.

The first longitudinal flow path LP1 may be short. The first longitudinal flow path LP1 does not need to reach the end of the first space SP1. The first longitudinal flow path LP1 includes at least a portion along the longitudinal direction of the first space SP1.

### Flows of Air

When the gun microphone wind shield 100 is used outdoors, a flow of air due to wind or the like contacts the gun microphone wind shield 100. Specifically, the air contacts the third covering body 13. The third covering body 13 contains the acoustic transmissive material that blocks part of the air in contact and transmits the remainder of the air. The air having passed through the third covering body 13 enters the second space SP2. The air having entered the second space SP2 is guided by contact with the second covering body 12 and the third covering body 13 and moves in the second space SP2 along the longitudinal direction. The movement of the air forms the second longitudinal flow path LP2.

In this way, part of the air in contact with the third covering body 13 is blocked and the remainder passes through the third covering body 13. Since only part of the air in contact with the third covering body 13 passes through the third covering body 13, the third covering body 13 can reduce the amount of the air entering the second space SP2 and suppress the momentum of the air. Further, the air having entered the second space SP2 gradually slows down by contact with the second covering body 12 and the third covering body 13. Accordingly, the momentum of the air can be suppressed.

The second covering body 12 contains the acoustic transmissive material that blocks part of the air in contact and transmits the remainder of the air. Some of the air having entered the second space SP2 may pass through the second covering body 12 depending on its amount and momentum.

The air having passed through the second covering body 12 enters the first space SP1. The air having entered the first space SP1 is guided by contact with the first covering body 11 and the second covering body 12 and moves in the first space SP1 along the longitudinal direction. The movement of the air forms the first longitudinal flow path LP1.

In this way, part of the air in contact with the second covering body 12 is blocked and the remainder passes through the second covering body 12. Since only part of the air in contact with the second covering body 12 passes through the second covering body 12, the second covering body 12 can reduce the amount of the air entering the first space SP1 and suppress the momentum of the air. Further, the air having entered the first space SP1 gradually slows down by contact with the first covering body 11 and the second covering body 12. Accordingly, the momentum of the air can be suppressed.

The gun microphone 30 is covered with the first covering body 11. Accordingly, even when the air enters the first space SP1, the first covering body 11 blocks the passage of the air to shut off whistling sounds properly.

Even when the gun microphone wind shield 100 is used outdoors, the second space SP2 and the first space SP1 can gradually reduce the amount of air and suppress the momentum of the air to block the passage of the air to the gun microphone 30 and shut off whistling sounds properly.

### Second Aspect

### Elastic Foaming Body

According to a second aspect of the present invention in the first aspect of the present invention, an elastic foaming body with open cells (for example, an elastic foaming body 140 described later or the like) is provided in at least part of the first space SP1 or the second space SP2.

The elastic foaming body is preferably provided in at least one of the first space SP1 and the second space SP2. The elastic foaming body has open cells. The elastic foaming body can control the direction of a flow of air with the open cells, or block and slow down a flow of air gradually due to collision with the open cells. In this way, the elastic foaming body can change the direction of the air and/or suppress the velocity of the air.

Accordingly, the elastic foaming body can further change the direction and velocity of the air having entered the first space SP1 or the second space SP2.

### Third Aspect

### Second Circular Flow Path AP2

As illustrated in FIGS. 1A, 1B, and 1C, according to a third aspect of the present invention in the first aspect of the present invention, the second space SP2 has a second circular flow path AP2 (for example, a component AP20 moving along the circumferential direction described later or the like) in which the air having flowed into the second space SP2 through the third covering body moves along at least part of the circumference of the second covering body 12.

As illustrated in FIG. 1C, the second space SP2 has the second circular flow path AP2. The second circular flow path AP2 is a path in which the air having flowed into the second space SP2 moves along the direction that circles around the second covering body 12.

The second space SP2 is a space formed between the second covering body 12 and the third covering body 13. The third covering body 13 is arranged in a position separated from the second covering body 12, and the second space SP2 has a shape that circles around the second covering body 12. The second space SP2 acts as a region for facilitating the movement of the air in the direction that circles around the second covering body 12. The air having flowed into the second space SP2 is guided by contact with the second covering body 12 and the third covering body 13 to move along the direction that circles around the second covering body 12. The path of the movement of the air constitutes the second circular flow path AP2.

The second circular flow path AP2 does not always need to extend along the direction that circles around the second covering body 12 but includes at least a portion along the circling direction. For example, the second circular flow path AP2 may include a path toward to the second covering body 12, a path toward to the third covering body 13 or a path meandering through the second space SP2 as far as it includes a portion along the circling direction.

The second circular flow path AP2 may be short. The second circular flow path AP2 does not need to circle around the entire second covering body 12. The second circular flow path AP2 includes at least a portion in which the air moves along the direction that circles around the second covering body 12.

### The Second Longitudinal Flow Path LP2 and the Second Circular Flow Path AP2

As described above, the second space SP2 has the second longitudinal flow path LP2 and the second circular flow path AP2. The second longitudinal flow path LP2 and the second circular flow path AP2 refer to components of the movement directions of the air flowing in the second space SP2. The second longitudinal flow path LP2 refers to the component of the air that flows and moves in the second space SP2 along the longitudinal direction of the second covering body 12. The second circular flow path AP2 refers to the component of the air that flows and moves in the second space SP2 along the direction that circles around the second covering body 12. The air flowing in the second space SP2 has the component that moves along the longitudinal direction of the second covering body 12 and the component that moves along the direction that circles around the second covering body 12.

### Fourth Aspect

### First Circular Flow Path AP1

As illustrated in FIGS. 1A, 1B, and 1C, according to a fourth aspect of the present invention in the first aspect of the present invention, the first space SP1 has a first circular flow path AP1 (for example, a component AP10 moving along the circumferential direction described later or the like) in which the air having flowed into the first space SP1 through the second covering body 12 moves along at least part of the circumference of the first covering body 11.

As illustrated in FIG. 1C, the first space SP1 has a first circular flow path AP1. The first circular flow path AP1 is a path in which the air having flowed into the first space SP1 moves along the direction that circles around the first covering body 11.

The first space SP1 is a space formed between the first covering body 11 and the second covering body 12. The second covering body 12 is arranged in a position separated from the first covering body 11, and the first space SP1 has a shape that circles around the first covering body 11. The first space SP1 acts as a region for facilitating the movement of the air in the direction that circles around the first covering body 11. The air having flowed into the first space SP1 is guided by contact with the first covering body 11 and the second covering body 12 to move along the direction that circles around the first covering body 11. The path of the movement of the air constitutes the first circular flow path AP1.

The first circular flow path AP1 does not always need to extend along the direction that circles around the first covering body 11 but includes at least a portion along the circling direction. For example, the first circular flow path AP1 may include a path toward to the first covering body 11, a path toward to the second covering body 12 or a path meandering through the first space SP1 as far as it includes a portion along the circling direction.

The first circular flow path AP1 may be short. The first circular flow path AP1 does not need to circle around the entire first covering body 11. The first circular flow path AP1 includes at least a portion in which the air moves along the direction that circles around the first covering body 11.

### The First Longitudinal Flow Path LP1 and the First Circular Flow Path AP1

As described above, the first space SP1 has the first longitudinal flow path LP1 and the first circular flow path AwP1. The first longitudinal flow path LP1 and the first circular flow path AP1 refer to components of the movement directions of the air flowing in the first space SP1. The first longitudinal flow path LP1 refers to the component of the air that flows and moves in the first space SP1 along the longitudinal direction of the first covering body 11. The first circular flow path AP1 refers to the component of the air that flows and moves in the first space SP1 along the direction that circles around the first covering body 11. The air flowing in the first space SP1 has the component that moves along the longitudinal direction of the first covering body 11 and the component that moves along the direction that circles around the first covering body 11.

### Fifth Aspect

### The Longitudinal Length of the First Covering Body 11 and the Longitudinal Length of the Second Covering Body 12

According to a fifth aspect of the present invention in the first aspect of the present invention, the longitudinal lengths of the first covering body 11 and the second covering body 12 are designed to be larger than a distance of the first space SP1 or a distance of the second space SP2.

The longitudinal lengths of the first covering body 11 and the second covering body 12 are larger than the distance of the first space SP1 or the distance of the second space SP2.

The distance of the first space SP1 constitutes the distance DT1 between the first covering body 11 and the second covering body 12. When the first covering body 11 and the second covering body 12 are columnar in shape and are concentric (coaxial) to each other, the distance of the first space SP1 is constant.

When the distance of the first space SP1 is not constant, a characteristic distance may be used. For example, the first space SP1 may have an average distance, a maximum distance, or a minimum distance.

The distance of the second space SP2 constitutes the distance DT2 between the second covering body 12 and the third covering body 13. When the second covering body 12 and the third covering body 13 are columnar in shape and are concentric (coaxial) to each other, the distance of the second space SP2 is constant.

When the distance of the second space SP2 is not constant, a characteristic distance may be used. For example, the first space SP1 may have an average distance, a maximum distance, or a minimum distance.

The first covering body 11 and the second covering body 12 are elongated in shape. The length of the first covering body 11 may be sufficiently larger than the distance of the first space SP1. Specifically, even the distance of the first space SP1 is made short, the longitudinal length of the first space SP1 can be ensured, which allows the first space SP1 to act as a region for moving the incoming air in the longitudinal direction. The length of the second covering body 12 may be sufficiently larger than the distance of the second space SP2. Specifically, even the distance of the second space SP2 is made short, the longitudinal length of the second space SP2 can be ensured, which allows the second space SP2 to act as a region for moving the incoming air in the longitudinal direction.

The distance of the second space SP2 can be set so that the air is less likely to flow into the first space SP1 according to the longitudinal length of the second covering body 12, the longitudinal length of the third covering body 13, and the presence or absence of an elastic foaming body.

The distance of the first space SP1 can be set so that the air is less likely to flow into the gun microphone 30 according to the longitudinal length of the first covering body 11, the longitudinal length of the second covering body 12, and the presence or absence of an elastic foaming body.

### Sixth Aspect

A sixth aspect of the present invention further includes a fourth covering body (for example, a basket 150 described later or the like) that has an elongated shape, covers and protects the third covering body, and has a sound transmissive opening that transmits sounds.

The fourth covering body has an elongated shape and covers and protects the third covering body. The fourth covering body preferably covers the entire third covering body. The fourth covering body has the sound transmissive opening that transmits sounds. The fourth covering body can protect the third covering body from deformation and breakage. The fourth covering body has the sound transmissive opening so that sounds emitted from a sound source can reach the gun microphone 300 without being attenuated or deteriorated.

### Seventh Aspect

A seventh aspect of the present invention further includes an elastic hold portion (for example, an elastic hold body 434 described later or the like) that holds elastically the first covering body 11 and the second covering body 12.

The elastic hold portion holds elastically the first covering body 11 and the second covering body 12. By elastically holding the first covering body 11 and the second covering body 12, the elastic hold portion can absorb external shock and prevent the shock from being picked up as noise by the gun microphone 300 due to the vibration of the first covering body 11 and the second covering body 12. In the embodiment, the shock includes shock resulting from a physical collision and sounds generated by wind and propagated as vibration through a solid object (hereinafter, called solid-borne sounds or solid-borne noise). The solid-borne sounds are picked up as wind noise.

### Eighth Aspect

An eighth aspect of the present invention further includes a fixed-shape hold portion (for example, brackets 440 described later or the like) that is provided in the elastic hold portion, retains the first covering body 11 and the second covering body 12 to hold the shapes of the first covering body 11 and the second covering body 12, and keep a distance (for example, the first space SP1 described later or the like) between the first covering body 11 and the second covering body 12

The fixed-shape hold portion is provided in the elastic hold portion to retain the first covering body 11 and the second covering body 12 and hold the shapes of the first covering body 11 and the second covering body 12. The fixed-shape hold portion keeps the distance between the first covering body 11 and the second covering body 12. For example, even when the first covering body 11 and the second covering body 12 are made from members likely to deform, the first covering body 11 and the second covering body 12 can be kept in their fixed shapes so that the distance between them is kept. Keeping the distance between the first covering body 11 and the second covering body 12 makes it possible to form the longitudinal flow path and the circular flow path in which the incoming air can move.

### Ninth Aspect

The first covering body 11 may have a gun microphone hold portion (for example, the inside of a first acoustic transmissive body 110 described later or the like) that stores and holds the gun microphone.

The first covering body 11 may have the gun microphone hold portion. The gun microphone hold portion stores and holds the gun microphone in the first covering body 11. This makes it possible to store the gun microphone in the first covering body 11 without the use of a separate member such as an adapter for attaching the gun microphone to the first covering body 11, which allows the gun microphone to be attached and detached in an easy and simple manner.

### Tenth Aspect

A tenth aspect of the present invention further includes a grip portion (for example, a grip portion 410 described later or the like) that can be supported by the user and is detachably coupled to the elastic hold portion via the fourth covering body.

The grip portion is a member that is supportable by the user. For example, the grip portion can be handheld and supported by the user. The grip portion is detachably coupled to the elastic hold portion. The grip portion is coupled to the elastic hold portion with the fourth covering body therebetween. In other words, while the grip portion is coupled to the elastic hold portion, the fourth covering body is sandwiched between the grip portion and the elastic hold portion. The grip portion can be attached as necessary to simplify the handling of the gun microphone wind shield during transportation.

### Eleventh Aspect

An eleventh aspect of the present invention further includes a grip portion elastic hold body (for example, a vibration absorber 416 described later or the like) that is provided between the fourth covering body and the grip portion to hold elastically the fourth covering body.

The grip portion elastic hold body is an elastically deformable member to hold elastically the fourth covering body. The grip portion elastic hold body is provided between the fourth covering body and the grip portion. Even when shock or solid-borne sounds are applied to the grip portion, the grip portion elastic hold body can absorb the solid-borne sounds and shock to prevent the solid-borne sounds and shock from transferring to the fourth covering body and being picked up as noise by the gun microphone 300.

### First Embodiment

First, a gun microphone wind shield 100 according to a first embodiment will be described. The gun microphone wind shield 100 is different from a gun microphone wind shield 200 according to a second embodiment described later in the presence or absence of an elastic foaming body 140 in a second space SP20.

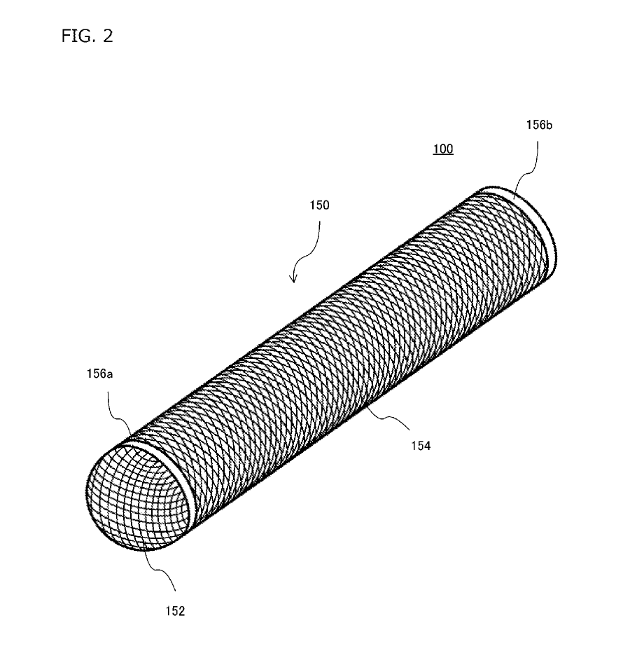

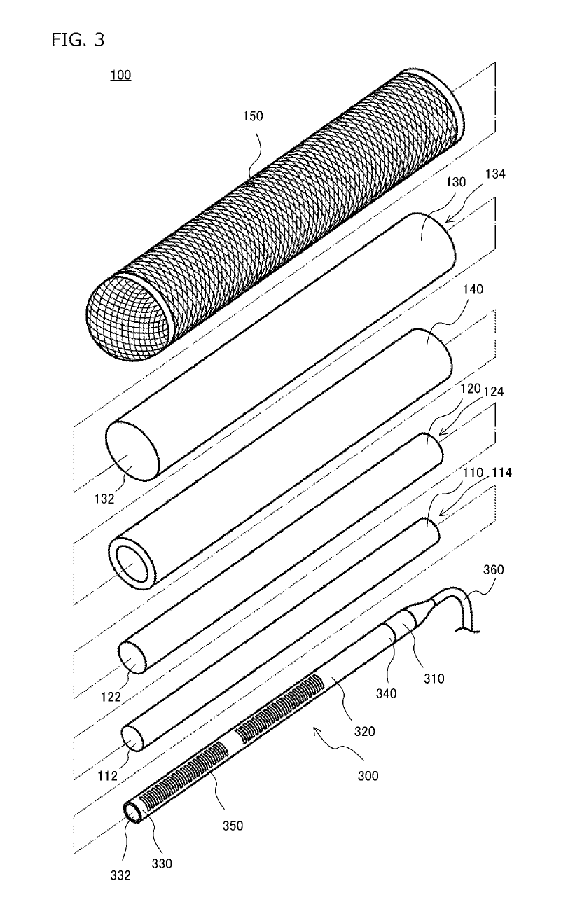

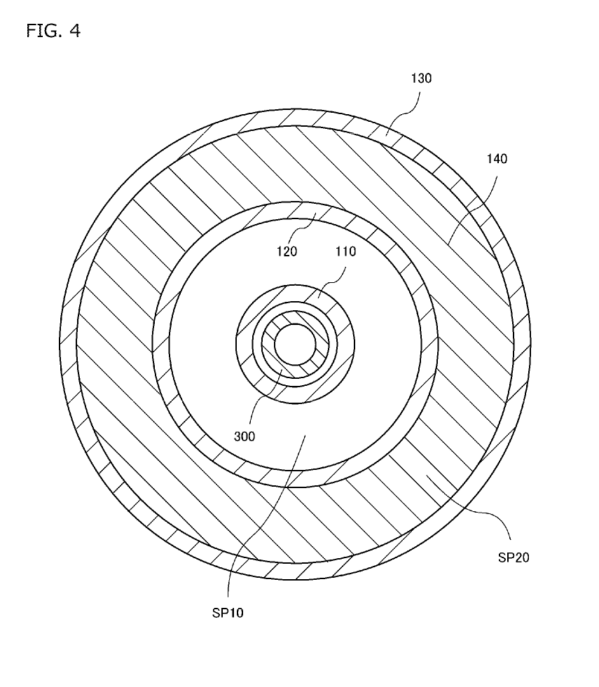

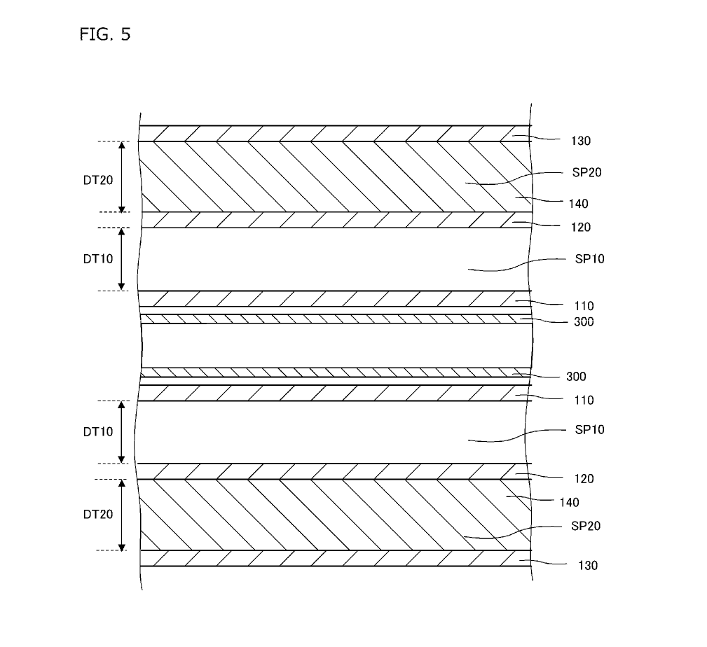

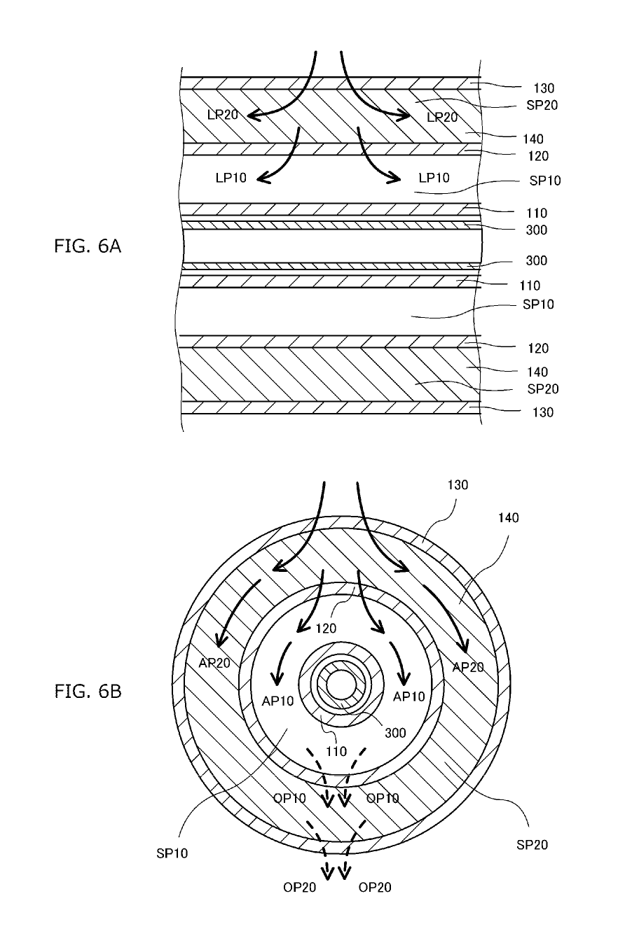

FIG. 2 is a perspective view of the entire gun microphone wind shield 100. FIG. 3 is a perspective view of a first acoustic transmissive body 110, a second acoustic transmissive body 120, a third acoustic transmissive body 130, an elastic foaming body 140, a basket 150, and a gun microphone 300 stored in the gun microphone wind shield 100. FIG. 4 is a cross-sectional view of the gun microphone wind shield 100 taken along a circumferential direction. FIG. 5 is a cross-sectional view of the gun microphone wind shield 100 taken along a longitudinal direction. FIG. 6 is a cross- sectional view (FIG. 6A) of longitudinal flows of air and is a cross-sectional view (FIG. 6B) of circumferential flows of air in a first space SP10 and a second space SP20.

### Gun Microphone Wind Shield 100

The gun microphone wind shield 100 according to the first embodiment is a wind shield for use in the gun microphone 300. The gun microphone 300 has high directivity and can cancel out surrounding noise and pick up sounds ahead of the gun microphone 300.

### Gun Microphone (Shot-Gun Microphone) 300

As illustrated in FIG. 3, the gun microphone 300 has an almost columnar and elongated outer shape. The gun microphone 300 mainly has a microphone body 310 and an interference tube 320.

The interference tube 320 has an elongated, almost cylindrical shape. The interference tube 320 has a first end 330 and a second end 340 along the longitudinal direction. The first end 330 has an opening 332. Directing the opening 332 to a sound source as a sound-pickup target makes it possible to transfer sounds emitted from the sound source to the inside of the interference tube via the opening 332.

The interference tube 320 has the second end 340 connected to the microphone body 310 having a diaphragm. The diaphragm vibrates on receipt of the sounds propagated through the interference tube 320. The microphone body 310 converts the vibration of the diaphragm into an electric signal and outputs the same as an audio signal.

Further, the side surface of the interference tube 320 has a plurality of slits 350. The sounds emitted from a sound source positioned on the lateral side of the gun microphone 300 (the interference tube 320) pass through the plurality of slits 350 and enter the inside of the interference tube 320. The sounds having passed through the plurality of slits 350 interfere with and cancel out each other in the interference tube. The sounds emitted from a sound source on the lateral side of the gun microphone 300 are not sound-pickup targets. Causing the sounds having passed through the plurality of slits 350 to cancel out each other prevents the sounds from reaching the microphone body 310. In this way, the gun microphone 300 includes the interference tube 320 to pick up sounds with enhanced directivity.

When the gun microphone is used outdoors, a flow of air such as wind is likely to contact not only the opening 332 but also the interference tube 320 in the gun microphone 300. As described above, the interference tube 320 has the plurality of slits 350 in the side surface, and thus a flow of air such as wind is likely to enter the interference tube 320 via the plurality of slits 350. When the air flows into the interference tube 320, the diaphragm of the microphone body 310 is likely to vibrate and cause wind noise due to the flow of the air. Accordingly, the gun microphone wind shield 100 needs to cover the entire gun microphone 300 including the interference tube 320.

### Main Components of the Gun Microphone Wind Shield 100

As illustrated in FIG. 3, the gun microphone wind shield 100 mainly has the first acoustic transmissive body 110, the second acoustic transmissive body 120, the third acoustic transmissive body 130, the elastic foaming body 140, and the basket 150. As described later, the first acoustic transmissive body 110, the second acoustic transmissive body 120, the third acoustic transmissive body 130, the elastic foaming body 140, and the basket 150 are all elongated in shape and are almost concentric (almost coaxial) to one another.

### The First Acoustic Transmissive Body 110, the Second Acoustic Transmissive Body 120, and the Third Acoustic Transmissive Body 130

The first acoustic transmissive body 110, the second acoustic transmissive body 120, and the third acoustic transmissive body 130 are all formed by curving an almost thin sheet-like acoustic transmissive member into a cylindrical shape. The acoustic transmissive member blocks the passage of part of contacting air. The remaining unblocked air passes through the acoustic transmissive member. The acoustic transmissive member will be described later in detail.

### Shape and Size

As illustrated in FIGS. 3, 4, and 5, the first acoustic transmissive body 110, the second acoustic transmissive body 120, and the third acoustic transmissive body 130 have an elongated and almost cylindrical shape. The first acoustic transmissive body 110, the second acoustic transmissive body 120, and the third acoustic transmissive body 130 are different in thickness. The first acoustic transmissive body 110 is the thinnest, the second acoustic transmissive body 120 is thicker, and the third acoustic transmissive body 130 is the thickest.

In other words, the first acoustic transmissive body 110, the second acoustic transmissive body 120, and the third acoustic transmissive body 130 are different in radius (diameter). The radius (diameter) of the first acoustic transmissive body 110 is the smallest, the radius (diameter) of the third acoustic transmissive body 130 is the largest, and the radius (diameter) of the second acoustic transmissive body 120 is larger than the radius (diameter) of the first acoustic transmissive body 110 and smaller than the radius (diameter) of the third acoustic transmissive body 130.

In addition, the first acoustic transmissive body 110, the second acoustic transmissive body 120, and the third acoustic transmissive body 130 are almost identical in longitudinal length (the height of the cylinder). The longitudinal ends of the first acoustic transmissive body 110, the second acoustic transmissive body 120, and the third acoustic transmissive body 130 can be aligned with one another.

A sound source-side end 112 of the first acoustic transmissive body 110, a sound source-side end 122 of the second acoustic transmissive body 120, and a sound source-side end 132 of the third acoustic transmissive body 130 are all blocked with the acoustic transmissive member. This makes the incoming air via a leading end portion 152 of the basket 150 less likely to enter the first acoustic transmissive body 110, the second acoustic transmissive body 120, and the third acoustic transmissive body 130.

An end 114 of the first acoustic transmissive body 110 opposite to the sound source side, an end 124 of the second acoustic transmissive body 120 opposite to the sound source side, and an end 134 of the third acoustic transmissive body 130 opposite to the sound source side are all opened. This makes it possible to achieve a balance in the air between the first space SP10 and the second space SP20 described later and facilitate the attenuation of the air as a whole to weaken an abrupt flow of air.

### Arrangement

As illustrated in FIGS. 3, 4, and 5, by forming the first acoustic transmissive body 110, the second acoustic transmissive body 120, and the third acoustic transmissive body 130 in such shapes and sizes as described above, it is possible to arrange sequentially the first acoustic transmissive body 110, the second acoustic transmissive body 120, and the third acoustic transmissive body 130 in an almost concentric (coaxial) manner so that the first acoustic transmissive body 110 is covered by the second acoustic transmissive body 120, and the second acoustic transmissive body 120 is covered by the third acoustic transmissive body 130.

The first acoustic transmissive body 110 and the second acoustic transmissive body 120 are radially separated from each other, and the second acoustic transmissive body 120 and the third acoustic transmissive body 130 are radially separated from each other.

As described later, the gun microphone 300 is arranged inside the first acoustic transmissive body 110 along the longitudinal direction. The radius of the first acoustic transmissive body 110 is designed to be slightly larger than the radius of the gun microphone 300 to be used.

The first acoustic transmissive body 110 also acts as a hold member for storing and holding the gun microphone 300 in a detachable manner. The first acoustic transmissive body 110 has a cylindrical shape, and the longitudinal length of the first acoustic transmissive body 110 is larger than the longitudinal length of the gun microphone 300. Accordingly, the gun microphone 300 can be smoothly attached to or detached from the first acoustic transmissive body 110, and the entire gun microphone 300 can be stored in the first acoustic transmissive body 110, while the leading end of the gun microphone has a gap (air layer).

### Acoustic Transmissive Member

The acoustic transmissive member is formed from a fiber material obtained by intertwining a raw material containing fibers, and the air permeability of the fiber material is less than 0.5 s/100 ml. This is because the fiber material used as the acoustic transmissive material is obtained by interlacing a raw material with an air permeability of 0.5 s/100 ml and thus provides a fiber density enough to have an uncountable number of irregular air gaps to shut off wind of a cause of whistling sounds.

That is, the acoustic transmissive member made from such a fiber material acts as a shield or a movement direction converter (flap) for “wind” of movement of an air molecule mass, and is almost completely permeable to “sound” of movement of pressure change (the medium itself does not move but only vibrate).

When the fiber material has enough freestanding properties (stiffness), the acoustic transmissive member does not need to be combined with any other member. However, the acoustic transmissive member may be configured so that the fiber material is sandwiched between two net-like bodies, for example.

The acoustic transmissive member will be described below in detail.

As described above, the acoustic transmissive member transmits a predetermined frequency range (20 to 20 kHz) and the constituent fiber material has an air permeability of less than 0.5 s/100 ml. With the foregoing properties, the acoustic transmissive member is significantly improved in acoustic transmissivity. The air permeability means the time taken for a certain amount of air to pass through a certain area under a certain pressure. In particular, it means the time taken for an air of 100 ml to pass through a sheet-like acoustic transmissive material. The air permeability is measured by Gurley method stipulated in JIS P8117.

The air permeability of less than 0.5 s/100 ml means that it falls under a measurable range of 0.5 s/100 ml or more of the measurement device used in the present application.

The acoustic transmissive member is obtained by interlacing a raw material containing fibers. For example, a fiber material with interlaced fibers can be formed by a wet forming method. The raw material used for manufacture of the fiber material is metallic fibers or fluorine fibers in this embodiment. The fiber material used as the acoustic transmissive member has a thickness of 3 mm or less, preferably 10 μm to 2000 μm, more preferably 20 μm to 1500 μm. Setting such a thickness makes it possible to obtain the effect of reducing whistling sounds by a minimum and simple structural frame with a certain degree of stiffness.

However, the raw material for the fiber material is not limited to a metallic fiber or a fluorine fiber, and the thickness of the fiber material is not limited to the foregoing values.

Next, the material for metallic fibers as a raw material for the fiber material will be described.

To manufacture the acoustic transmissive member from metallic fibers using a wet forming method, the metallic fiber material is obtained by processing slurry containing one or two or more kinds of metallic fibers using a wet forming method. To manufacture the acoustic transmissive member from metallic fibers using compression molding, the metallic fiber material is obtained using heating and pressurizing an aggregate of metallic fibers. In either case, the resultant metallic fiber material has interlaced metallic fibers. There is no particular limitation on the shape of the metallic fiber material but the metallic fiber material is preferably a metallic fiber sheet.

The material, structure, and manufacturing method of the metallic fibers will be described below in detail. The descriptions in JP 2000-80591 A, Japanese Patent No. 2649768, and Japanese Patent No. 2562761, which provide the metallic fiber material and the method for manufacturing the same, are incorporated by reference in its entirety.

One or two or more kinds of metallic fibers as the material for metallic fibers are one or two or more kinds selected from fibers made from stainless steel, aluminum, brass, copper, titanium, nickel, gold, platinum, lead, and the like.

The metallic fiber material has a structure that metallic fibers are interlaced. The metallic fibers constituting the metallic fiber has a fiber diameter of 1 μm to 50 μm, preferably 2 μm to 30 μm, more preferably 8 μm to 20 μm. Such metallic fibers are suited for interlacing, and interlacing such metallic fibers makes it possible to form a low-lint metallic fiber sheet with acoustic transmissivity.

The manufacture of the metallic fiber material by a wet forming method includes a fiber interlacing process in which the metallic fibers as a net-like wet sheet are interlaced while slurry containing one or two or more kinds of metallic fibers is shaped into a sheet form using a wet forming method.

In the fiber interlacing process, preferably, high-pressure jets of water are sprayed onto the metallic fiber sheet after papermaking, for example. Specifically, a plurality of nozzles is arranged in a direction orthogonal to the flowing direction of the sheet to spray high-pressure jets of water at the same time to interlace the metallic fibers in the entire sheet. That is, when high-pressure jets of water are sprayed onto the sheet of metallic fibers crossed one another irregularly in a plane direction by wet forming, in a Z-axis direction of the sheet, for example, the metallic fibers onto which the high-pressure jets of water have been sprayed are oriented in the Z-axis direction. The metallic fibers oriented in the Z-axis direction gets tangled with the metallic fibers oriented irregularly in the plane direction. These fibers are tangled with one another three-dimensionally, that is, are interlaced to obtain physical strength.

In addition, the sheet forming method may be selected as necessary from various methods such as Fourdrinier forming, cylinder forming, and inclined wire forming. At manufacture of slurry containing long metallic fibers, dispersiveness of the metallic fibers in the water may be insufficient. Accordingly, a small amount of polymer aqueous solution with thickening properties may be added to the slurry. The polymer includes polyvinyl pyrrolidone, polyvinyl alcohol, or carboxymethyl cellulose (CMC).

According to the method for manufacturing the metallic fiber material by compression molding, first, the fibers are brought together and compressed preliminarily to form a web, or the fibers are impregnated with a binder to bind the fibers and then compressed preliminarily. After that, the aggregate of metallic fibers is heated and pressurized to form a metallic fiber sheet. There is no particular limitation on the binder. For example, organic binders such as an acrylic adhesive, an epoxy adhesive, and a urethane adhesive, and inorganic adhesives such as colloidal silica, water glass, and sodium silicate can be used. Instead of impregnating the fibers with a binder, the surface of the fibers may be covered in advance with a thermobonding resin, and an aggregate of metallic fibers may be layered, and then heated and bonded. The amount of impregnation with a binder is preferably 5 to 130 g, more preferably 20 to 70 g for a sheet plane weight of 1000 g/m2.

The aggregate of metallic fibers is heated and pressurized to form the sheet. The heating conditions are set in consideration to the binder used, and the drying temperature and curing temperature of the thermobonding resin. The heating temperature is generally about 50 to 1000° C. The applied pressure is adjusted in consideration to the elasticity of the fibers, the thickness of the acoustic transmissive member, and the light transmissivity of the acoustic transmissive member. To impregnate the acoustic transmissive member with a binder by spraying, the metallic fiber layer is preferably molded to a predetermined thickness by pressing or the like prior to the spraying.

In addition, the method for manufacturing the metallic fiber material preferably includes a sintering process in which, after the wet forming process described above, the obtained metallic fiber material is sintered at a temperature equal to or lower than the melting point of the metallic fibers in vacuum or in a non-oxidizing atmosphere (in the case of compression molding, a heating and pressurization process substitutes for the sintering process). That is, after the wet forming process, the sintering process is performed to interlace the fibers, which eliminates the need to add an organic binder or the like to the metallic fiber material. This makes it possible to manufacture the metallic fiber material with a metal-specific glossy surface without trouble in the sintering process that might be caused by a cracked gas from an organic binder or the like. In addition, the metallic fibers are interlaced to further improve the strength of the sintered metallic fiber material. Further, the sintered metallic fiber material is high in acoustic transmissivity and water-proof property. If not being sintered, the remaining thickening polymers in the metallic fiber material might absorb water to deteriorate water-proof property.

Next, the material for fluorine fibers as a raw material for the fiber material will be described.

In the case of using the fluorine fibers, the fluorine fiber material becomes a material (paper) in which short fluorine fibers are oriented in irregular directions and are bonded by thermal fusion.

The material and method for manufacturing the fluorine fibers will be described below in detail. As the material and method for manufacturing the fluorine fiber material, the descriptions in JP 63-165598 A are incorporated by reference in its entirety.

The fluorine fibers are produced from a thermoplastic fluorine resin mainly containing polytetrafluoroethylene (PTFE), tetrafluoroethylene (TFE), perfluoroether (PFE), copolymer of tetrafluoroethylene and hexafluoropropylene (FEP), copolymer of tetrafluoroethylene and ethylene or propylene (ETFE), polyvinylidene fluoride (PVDF), polychlorotrifluoroethylene (PCTFE), or polyvinyl fluoride (PVF). However, the main ingredients are not limited to them but may be mixed with the foregoing or other ones. The fluorine fibers are preferably single fibers with a fiber length of 1 to 20 mm so that they can be shaped into sheet form by a wet forming method. In addition, the fluorine fibers preferably have a fiber diameter of 2 to 30 μm.

The fluorine fiber material can be produced by mixing and drying the fluorine fibers and a self-adhesiveness substance by a wet forming method into a fluorine fiber-mixed sheet material, subjecting the sheet material to thermal compression bonding at the softening point of the fluorine fibers or more to fuse thermally the fluorine fibers, removing the self-adhesiveness substance by solving in a solvent, and re-drying the material as necessary.

The self-adhesiveness substance may be natural pulp made from plant fibers such as wood, cotton, hemp, and straw generally used for paper making, synthetic pulp or synthetic fibers made from polyvinyl alcohol (PVA), polyester, aromatic polyamide, acryl or polyolefin thermoplastic synthetic copolymers, or a paper strength additive made from natural copolymers or synthetic copolymers. However, the self-adhesiveness substance is not limited to them as far as it has self-adhesiveness and can be dispersed in water together with fluorine fibers.

The acoustic transmissive member of the present invention is not limited to the foregoing ones as far as the acoustic transmissive member includes a fiber material obtained by shaping a raw material containing fibers into sheet form by a wet forming method and the fiber material has an air permeability of less than 0.5 s/100 ml.

As described above, the acoustic transmissive member has a fiber density enough to have uncountable irregular air gaps and can shut off wind as a cause of whistling sounds. The acoustic transmissive member formed from a fiber material acts as a shield or a movement direction converter (flap) for “wind” as movement of an air molecule mass, and is almost completely permeable to “sound” as movement of pressure change (the medium itself does not move but only vibrate).

The first acoustic transmissive body 110, the second acoustic transmissive body 120, and the third acoustic transmissive body 130 are made of the foregoing acoustic transmissive member and can basically shut off wind of a cause of whistling sounds. However, the gun microphone 300 is used outdoor in many cases and is susceptible to wind. In addition, the gun microphone 300 has an elongated shape to increase inevitably a large area to contact wind. Accordingly, it is necessary to provide the first acoustic transmissive body 110, the second acoustic transmissive body 120, and the third acoustic transmissive body 130 to form the first space SP10 and the second space SP20 described later and shut off a flow of air.

### The First Space SP10 and the Second Space SP20

As describe above, the first acoustic transmissive body 110 and the second acoustic transmissive body 120 are almost concentric to each other and separated from each other. This makes it possible to define the first space SP10 in a region sandwiched between the first acoustic transmissive body 110 and the second acoustic transmissive body 120 (see FIGS. 4 and 5). The first space SP10 is almost cylindrical clearance as a whole. The longitudinal length of the first space SP10 is determined by the longitudinal lengths of the first acoustic transmissive body 110 and the second acoustic transmissive body 120. The thickness of side surface of the first space SP10 constitutes a distance DT10 between the first acoustic transmissive body 110 and the second acoustic transmissive body 120, which is determined by the difference between the radius of the first acoustic transmissive body 110 and the radius of the second acoustic transmissive body 120.

Similarly, the second space SP20 can be defined in a region sandwiched between the second acoustic transmissive body 120 and the third acoustic transmissive body 130 (see FIGS. 4 and 5). The second space SP20 is an almost cylindrical clearance as a whole. The longitudinal length of the second space SP20 is determined by the longitudinal lengths of the second acoustic transmissive body 120 and the third acoustic transmissive body 130. The thickness of side surface of the second space SP20 constitutes a distance DT20 between the second acoustic transmissive body 120 and the third acoustic transmissive body 130, which is determined by the difference between the radius of the second acoustic transmissive body 120 and the radius of the third acoustic transmissive body 130.

### Elastic Foaming Body 140

The elastic foaming body 140 is generally produced by foam-molding of a synthetic resin such as polyurethane, and is formed from a sponge-like elastic foaming body with open cells. The elastic foaming body 140 is provided over the entire second space SP20. Therefore, the elastic foaming body 140 has the same shape and size as those of the second space SP20, and the second space SP20 is occupied by (charged with) the elastic foaming body 140.

The elastic foaming body 140 may be charged with the entirety or part of the second space SP20. For example, the cylindrical elastic foaming body 140 may be stuck to the inside of the third acoustic transmissive body 130 to form a gap from the outside of the second acoustic transmissive body 120. Alternatively, the elastic foaming body 140 may be provided only on the central portion or both end portions of the second space SP20. The elastic foaming body 140 can be provided as appropriate to attenuate the flow of air in the second space SP20.

### Basket 150

As illustrated in FIGS. 2 and 3, the basket 150 is a covering body that protects entirely the gun microphone 300, the first acoustic transmissive body 110, the second acoustic transmissive body 120, the third acoustic transmissive body 130, and the elastic foaming body 140. The basket 150 has a function of transmitting sounds and protecting the gun microphone 300 and others stored therein.

### Shapes and Sizes

The basket 150 has a leading end portion 152 and a cylindrical portion 154. The leading end portion 152 has an almost hemispheric shape. The cylindrical portion 154 has an elongated cylindrical shape. The leading end portion 152 and the cylindrical portion 154 are mesh-like with fine gaps to transmit external sounds.

The radius of the cylindrical portion 154 is slightly longer than the radius of the third acoustic transmissive body 130. The longitudinal length of the cylindrical portion 154 is slightly larger than the longitudinal lengths of the first acoustic transmissive body 110, the second acoustic transmissive body 120, the third acoustic transmissive body 130, and the elastic foaming body 140.

The cylindrical portion 154 has a first end 156a and a second end 156b along the longitudinal direction. The leading end portion 152 can be detachably attached to the first end 156a of the cylindrical portion 154. The second end 156b has an almost circular opening. The first acoustic transmissive body 110, the second acoustic transmissive body 120, the third acoustic transmissive body 130, and the elastic foaming body 140 can be inserted and stored in the cylindrical portion 154 of the basket 150 from the opening in the second end 156b. In other words, the first acoustic transmissive body 110, the second acoustic transmissive body 120, the third acoustic transmissive body 130, and the elastic foaming body 140 can be entirely covered with the basket 150.

The first acoustic transmissive body 110, the second acoustic transmissive body 120, the third acoustic transmissive body 130, and the elastic foaming body 140 may be fixed in predetermined positions by a fixing member (not illustrated) in the basket 150. In this way, the first acoustic transmissive body 110, the second acoustic transmissive body 120, the third acoustic transmissive body 130, the elastic foaming body 140, and the basket 150 are integrated. These components may be integrated in a fixed or detachable manner.

The opening 332 in the interference tube 320 of the gun microphone 300 is positioned on the inside of the leading end portion 152. An acoustic transmissive body (not illustrated) is also provided on the inside of the leading end portion 152. Besides the acoustic transmissive body, the elastic foaming body 140 may be provided on the inside of the leading end portion 152.

The third acoustic transmissive body 130 may be provide over the entire inner peripheral surface of the basket 150 so that the third acoustic transmissive body 130 and the basket 150 can be integrated. This makes it possible to facilitate the attachment of the third acoustic transmissive body 130 and keep constantly the shape of the third acoustic transmissive body 130.

### Material

The basket 150 can transmit sounds and protect the first acoustic transmissive body 110 and others stored therein. For example, the basket 150 can be formed from a resin such as reinforced plastic or a metal such as plastic aluminum.

The radius of the cylindrical portion 154 is longer than the radius of the third acoustic transmissive body 130. The longitudinal length of the cylindrical portion 154 is slightly larger than the longitudinal lengths of the first acoustic transmissive body 110, the second acoustic transmissive body 120, the third acoustic transmissive body 130, and the elastic foaming body 140.

Integrating the first acoustic transmissive body 110, the second acoustic transmissive body 120, the third acoustic transmissive body 130, the elastic foaming body 140, and the basket 150 makes it possible to form the gun microphone wind shield 100.

Storing the gun microphone 300 in the first acoustic transmissive body 110 along the inside of the first acoustic transmissive body 110 makes it possible to cover the gun microphone 300 with the gun microphone wind shield 100. As illustrated in FIG. 3, the gun microphone 300 is connected to a cable 360 for outputting electrical signals. The gun microphone wind shield 100 has a size enough to cover the entire gun microphone 300 including a connection end portion where the cable 360 is connected to the gun microphone 300.

### Flows of Air in the First Space SP10 and the Second Space SP20 (Change in Pressure)

Referring to FIG. 6, flows of air having entered the first space SP10 and flows of air having entered the second space SP20 will be describe below.

### Flows of Air in the Second Space SP20 (Change in Pressure)

FIG. 6A is a cross-sectional view of flows of air guided in the second space SP20 along the longitudinal direction. FIG. 6B is a cross-sectional view of flows of air guided in the second space SP20 along the circumferential direction (the direction that circles around the second acoustic transmissive body 120). For the sake of clarity, FIGS. 6A and 6B do not illustrate the basket 150.

The second space SP20 is a region sandwiched between the second acoustic transmissive body 120 and the third acoustic transmissive body 130. The second space SP20 is charged with the elastic foaming body 140.

The air having passed through the basket 150 first contacts the acoustic transmissive member in the third acoustic transmissive body 130. Part of the air in contact is shut off by the acoustic transmissive member. For example, the shut air moves along the acoustic transmissive member or is reflected by the acoustic transmissive member. The remainder of the air not shut off by the acoustic transmissive member passes through the acoustic transmissive member. Shutting off part of the air by the acoustic transmissive member makes it possible to reduce the amount of air passing through the acoustic transmissive member and entering the second space SP20 (the elastic foaming body 140).

The air having entered the second space SP20 then enters the elastic foaming body 140. The elastic foaming body 140 has open cells and the air having entered the elastic foaming body 140 moves along the open cells. The elastic foaming body 140 can control the flowing direction of the air. In addition, the flow of the air can be interfered and slowed down gradually by collision with the open cells. In this way, the elastic foaming body 140 can suppress the velocity of the air.

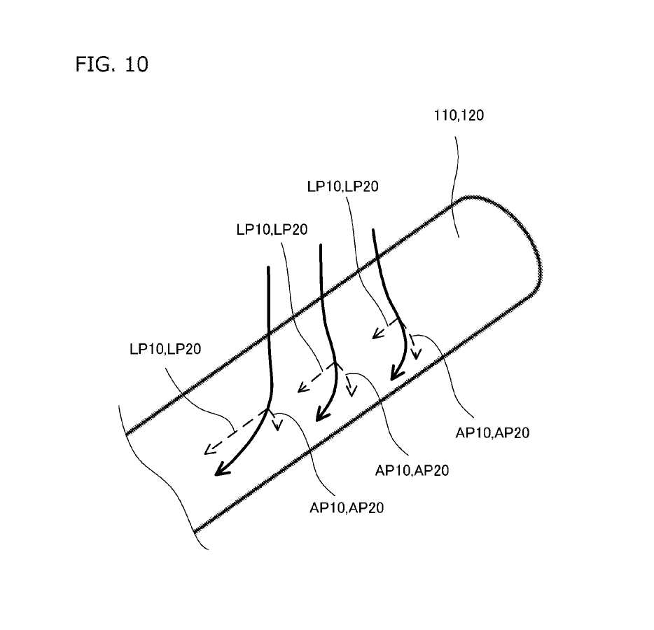

In addition, the second space SP20 (the elastic foaming body 140) is sandwiched between the second acoustic transmissive body 120 and the third acoustic transmissive body 130, and the air having entered the elastic foaming body 140 travels while being interfered with by each contact with the second acoustic transmissive body 120 and the third acoustic transmissive body 130. In this way, the air having entered the elastic foaming body 140 moves in the second space SP20 while being guided by the second acoustic transmissive body 120 and the third acoustic transmissive body 130, and then gradually slows down by the contact with the second acoustic transmissive body 120, the third acoustic transmissive body 130, and the elastic foaming body 140 (see FIG. 10).

The air moving in the second space SP20 has a component LP20 moving along the longitudinal direction of the second acoustic transmissive body 120 and the third acoustic transmissive body 130 (see FIGS. 6A and 10) and a component AP20 moving along the circumferential direction of the second acoustic transmissive body 120 and the third acoustic transmissive body 130 (see FIGS. 6B and 10).

### Longitudinal Flows of Air in the Second Space SP20

The second acoustic transmissive body 120 and the third acoustic transmissive body 130 have an elongated shape adapted to the gun microphone 300 to cover the gun microphone 300 in the longitudinal direction. Accordingly, the second space SP20 sandwiched between the second acoustic transmissive body 120 and the third acoustic transmissive body 130 also has an elongated and almost cylindrical shape, and the second space SP20 is a space that exists (extends) in the longitudinal direction according to the longitudinal length of the gun microphone 300.

The longitudinal length of the second space SP20 can be decided depending on the outer shape of the used gun microphone 300. For example, the longitudinal length of the second space SP20 may be almost identical to or slightly larger than the longitudinal length of the gun microphone 300, and can be ten times or more the diameter of the gun microphone 300.

The second space SP20 is a region that allows the air to flow in the longitudinal direction, and the air having entered the second space SP20 can move in the longitudinal direction. Specifically, the air having entered the second space SP20 can be guided in the longitudinal direction by the second acoustic transmissive body 120 and the third acoustic transmissive body 130 and gradually slowed down by the elastic foaming body 140. Providing the second space SP20 as the space where the air can move sufficiently in the longitudinal direction increases the opportunities to move and slow down the air gradually, thereby making the air less likely to enter the first space SP10 from the second space SP20.

In this way, the second space SP20 provides a region where the air can flow in the longitudinal direction, and acts as an air flow buffer area to make the air less likely to enter the first space SP10.

### Circumferential Flows of Air in the Second Space SP20

The second acoustic transmissive body 120 and the third acoustic transmissive body 130 have an almost cylindrical shape and cover the gun microphone 300 to circle around the gun microphone 300. Accordingly, the second space SP20 sandwiched between the second acoustic transmissive body 120 and the third acoustic transmissive body 130 also has an almost cylindrical shape circling around the gun microphone 300. The second space SP20 is a space that covers the gun microphone 300 in the circumferential direction.

The diametrical thickness of the second space SP20 can be decided depending on the diameter of the gun microphone 300. For example, the diametrical thickness of the second space SP20 can be equal to or less than the diameter of the gun microphone 300 or can be equal to or less than the radius of the gun microphone 300. In addition, the diametrical thickness of the second space SP20 may be larger than the diameter of the gun microphone 300.

In any case, the second space SP20 only needs to act as an air flow buffer area and provide a space where the air can move sufficiently. The space where the air can move sufficiently can be decided by a balance between the longitudinal length of the second space SP20 and the diametrical thickness of the second space SP20. For example, even when the diametrical thickness of the second space SP20 is shortened, increasing the longitudinal length of the second space SP20 can provide a space where the air can move sufficiently.

The second space SP20 is a region for flowing the air in the circumferential direction, and the air having entered the second space SP20 can move along the circumferential direction. Specifically, the air having entered the second space SP20 can be guided in the circumferential direction by the second acoustic transmissive body 120 and the third acoustic transmissive body 130 and gradually slowed down by the elastic foaming body 140. Providing the second space SP20 as the space where the air can move sufficiently in the circumferential direction increases the opportunities to move and slow down the air gradually, thereby making the air less likely to enter the first space SP10 from the second space SP20.

In this way, the second space SP20 provides a region where the air can flow in the longitudinal direction and the circumferential direction, and acts as an air flow buffer area to make the air less likely to enter the first space SP10.

### Flows of Air in the Second Space SP20

As described above, the air having entered the second space SP20 has the component LP20 that moves along the longitudinal direction (see FIGS. 6A and 10), and the component AP20 that moves along the circumferential direction (see FIGS. 6B and 10). The longitudinal component LP20 and the circumferential component AP20 are determined by the angle and velocity distribution with respect to the third acoustic transmissive body 130 at the time of entry to the second space SP20.

The air of the longitudinal component LP20 moves along the longitudinal direction while being interfered with by the second acoustic transmissive body 120 and the third acoustic transmissive body 130, and is gradually slowed down by the elastic foaming body 140. The air of the circumferential component AP20 moves along the circumferential direction while being interfered with by the second acoustic transmissive body 120 and the third acoustic transmissive body 130, and is gradually slowed down by the elastic foaming body 140. In this way, the second space SP20 acts as a buffer area for gradually slowing down the air having entered the second space SP20.

The air having entered the second space SP20 is not only slowed down in the second space SP20 but also may flow in the circumferential direction and then come out from the opposite side of the second space SP20 to the outside of the basket 150 depending on the flow velocity, angle, flow amount, and the like (see arrows OP20 in FIG. 6). The air flowing in the second space SP20 is interfered with by the second acoustic transmissive body 120 and becomes less likely to enter the first space SP10.

### Flows of Air in the First Space SP10 (Change in Pressure

FIG. 6A is a cross-sectional view of flows of air guided in the first space SP10 along the longitudinal direction. FIG. 6B is a cross-sectional view of flows of air guided in the first space SP10 along the circumferential direction (the direction that circles around the first acoustic transmissive body 110). For the sake of clarity, FIGS. 6A and 6B do not illustrate the basket 150.

The first space SP10 is a region sandwiched between the first acoustic transmissive body 110 and the second acoustic transmissive body 120. The first space SP10 is not charged with the elastic foaming body 140, unlike the second space SP20. Depending on the use environment of the gun microphone 300, the first space SP10 may be charged with the elastic foaming body 140 as appropriate.

As described above, the second space SP20 (the elastic foaming body 140) acts as a buffer area for gradually slowing down the air having entered the second space SP20. Therefore, the air is less likely to pass through the second acoustic transmissive body 120. However, depending on the use environment of the gun microphone 300, the air might pass through the second acoustic transmissive body 120. When having passed through the second acoustic transmissive body 120, the air also enters the first space SP10.

The first space SP10 is sandwiched between the first acoustic transmissive body 110 and the second acoustic transmissive body 120, and the air having entered the first space SP10 travels while being interfered with by each contact with the first acoustic transmissive body 110 and the second acoustic transmissive body 120. In this way, the air having entered the first space SP10 moves in the first space SP10 while being attenuated by each contact with the first acoustic transmissive body 110 and the second acoustic transmissive body 120 (see FIG. 10).

As in the second space SP20, the air moving in the first space SP10 has a component LP10 moving along the longitudinal direction of the first acoustic transmissive body 110 and the second acoustic transmissive body 120 (see FIGS. 6A and 10) and a component AP10 moving along the circumferential direction of the first acoustic transmissive body 110 and the second acoustic transmissive body 120 (see FIGS. 6B and 10).

### Longitudinal Flows of Air in the First Space SP10

The first acoustic transmissive body 110 and the second acoustic transmissive body 120 have an elongated shape adapted to the gun microphone 300 to cover the gun microphone 300 in the longitudinal direction. Accordingly, the first space SP10 sandwiched between the first acoustic transmissive body 110 and the second acoustic transmissive body 120 also has an elongated and almost cylindrical shape, and the first space SP10 is a space that exists (extends) in the longitudinal direction according to the longitudinal length of the gun microphone 300.

The longitudinal length of the first space SP10 is almost identical to the longitudinal length of the second space SP20. Therefore, for example, the longitudinal (axial) length of the first space SP10 may be almost identical to or slightly larger than the longitudinal length of the gun microphone 300, and can be ten times or more the diameter of the gun microphone 300.

The first space SP10 is a region that allows the air to flow in the longitudinal direction, and the air having entered the first space SP10 can move in the longitudinal direction. Specifically, the air having entered the first space SP10 can be guided in the longitudinal direction by the first acoustic transmissive body 110 and the second acoustic transmissive body 120 and gradually slowed down by contact with the first acoustic transmissive body 110 and the second acoustic transmissive body 120. Providing the first space SP10 as the space where the air can move sufficiently in the longitudinal direction increases the opportunities to move and slow down the air gradually, which makes the air less likely to leak from the first space SP10 toward the gun microphone 300.

In this way, the first space SP10 provides a region where the air can flow in the longitudinal direction, and acts as an air flow buffer area to make the air less likely to enter the gun microphone 300.

### Circumferential Flows of Air in the First Space SP10

The first acoustic transmissive body 110 and the second acoustic transmissive body 120 have an almost cylindrical shape and cover the gun microphone 300 to circle around the gun microphone 300. Accordingly, the first space SP10 sandwiched between the first acoustic transmissive body 110 and the second acoustic transmissive body 120 also has an almost cylindrical shape circling around the gun microphone 300. The first space SP10 is a space that covers the gun microphone 300 in the circumferential direction.

The diametrical thickness of the first space SP10 can be decided depending on the diameter of the gun microphone 300. For example, the diametrical thickness of the first space SP10 can be equal to or less than the diameter of the gun microphone 300 or can be equal to or less than the radius of the gun microphone 300. In addition, the diametrical thickness of the first space SP10 may be larger than the diameter of the gun microphone 300.

The first space SP10 only needs to act as an air flow buffer area and provide a space where the air can move sufficiently. The space where the air can move sufficiently can be decided by a balance between the longitudinal length of the first space SP10 and the diametrical thickness of the first space SP10. For example, even when the diametrical thickness of the first space SP10 is shortened, increasing the longitudinal length of the first space SP10 can provide a space where the air can move sufficiently.

Further, the size of the first space SP10 may be decided depending on the size of the second space SP20. For example, when the size of the second space SP20 is significantly larger than the size of the first space SP10, the second space SP20 can keep most of the air having entered the second space SP20 to prevent the air from entering the first space SP10. In addition, when the size of the second space SP20 is smaller than the size of the first space SP10, the second space SP20 can keep part of the air having entered the second space SP20 to prevent the air from entering the first space SP10. The size of the first space SP10 and the size of the second space SP20 can be decided according to the use environment of the gun microphone 300 and the structure of the interference tube 320.

The first space SP10 is a region for flowing the air in the circumferential direction, and the air having entered the first space SP10 can move along the circumferential direction. Specifically, the air having entered the first space SP10 can be guided in the circumferential direction by the first acoustic transmissive body 110 and the second acoustic transmissive body 120 and gradually slowed down by contact with the first acoustic transmissive body 110 and the second acoustic transmissive body 120. Providing the first space SP10 as the space where the air can move sufficiently in the circumferential direction increases the opportunities to move and slow down the air gradually, which makes the air less likely to leak from the first space SP10 toward the gun microphone 300.

In this way, the first space SP10 provides a region where the air can flow in the circumferential direction, and acts as an air flow buffer area to make the air less likely to enter the gun microphone 300.

### Flows of Air in the First Space SP10

As described above, the air having entered the first space SP10 has the component LP10 that moves along the longitudinal direction (see FIGS. 6A and 10), and the component AP10 that moves along the circumferential direction (see FIGS. 6B and 10). The longitudinal component LP10 and the circumferential component AP10 are determined by the angle and velocity distribution with respect to the second acoustic transmissive body 120 at the time of entry to the first space SP10.

The air of the longitudinal component LP10 moves along the longitudinal direction while being interfered with by the first acoustic transmissive body 110 and the second acoustic transmissive body 120, and is gradually slowed down by the elastic foaming body 140. The air of the circumferential component AP10 moves along the circumferential direction while being interfered with by the first acoustic transmissive body 110 and the second acoustic transmissive body 120, and is gradually slowed down by the elastic foaming body 140. In this way, the first space SP10 acts as a buffer area for gradually slowing down the air having entered the first space SP10.

The air having entered the first space SP10 is not only slowed down in the first space SP10 but also may flow in the circumferential direction and then come out from the opposite side of the first space SP10 to the second space SP20 depending on the flow velocity, angle, flow amount, and the like (see arrows OP10 in FIG. 6). The air flowing in the first space SP10 is interfered with by the first acoustic transmissive body 110 and becomes less likely to reach the gun microphone 300.

Wind noise is generated by the air (wind) in direct contact with the diaphragm of the microphone body 310. As described above, first of all, the second space SP20 (the elastic foaming body 140) suppresses the movement of the air having entered the second space SP20 and then the first space SP10 suppresses the movement of the air having entered the first space SP10. In this way, the first space SP10 and the second space SP20 suppress the movement of the air and make the air less likely to leak toward the gun microphone 300. This makes the movement of the air less likely to transfer to the diaphragm of the microphone body 310 of the gun microphone 300 and prevents wind noise.

### Suppression of Negative Pressure Fluctuation in the First Space SP10 and the Second Space SP20

As described above, air flows into the microphone body 310 of the gun microphone 300 to vibrate the diaphragm and generate wind noise. Further, wind noise is generated not only by the direct inflow of air but also by fluctuation in the surrounding pressure.

Slight pressure fluctuation, specifically, negative pressure fluctuation that occurs around the gun microphone 300 may vibrate the diaphragm of the microphone body 310 to generate wind noise. The gun microphone wind shield 100 suppresses such negative pressure fluctuation and prevents the occurrence of wind noise by the negative pressure fluctuation.

First, when air flows outside the basket 150 to generate negative pressure fluctuation in the second space SP20, the longitudinal movement of the air and the circumferential movement of the air are generated in the second space SP20 (the elastic foaming body 140) to suppress the negative pressure fluctuation in the second space SP20. Suppressing the negative pressure fluctuation in the second space SP20 makes it possible to prevent the occurrence of negative pressure fluctuation in the first space.

In addition, even when the negative pressure fluctuation in the second space SP20 is transferred to the first space SP10 to cause negative pressure fluctuation in the first space SP10, the longitudinal movement of the air and the circumferential movement of the air are generated in the first space SP10 to suppress the negative pressure fluctuation in the first space SP10. Suppressing the negative pressure fluctuation in the first space SP10 makes it possible to prevent the transfer of the negative pressure fluctuation to the diaphragm of the gun microphone 300.

Causing proactively the longitudinal movement of the air and the circumferential movement of the air in each of the first space SP10 and the second space SP20 makes it possible to suppress negative pressure fluctuation. The second space SP20 (the elastic foaming body 140) has an elongated shape that can move the air sufficiently in the longitudinal direction. The second acoustic transmissive body 120, the third acoustic transmissive body 130, and the elastic foaming body 140 contact the moving air to slow down the air gradually.

The first space SP10 also has an elongated shape that can move the air sufficiently in the longitudinal direction. The first acoustic transmissive body 110 and the second acoustic transmissive body 120 contact the moving air to slow down the air gradually.

The gun microphone wind shield 100 has the first space SP10 and the second space SP20 to move the air sufficiently in the longitudinal direction and slow down the moving air, thereby absorbing negative pressure fluctuation. In this way, providing the first space SP10 and the second space SP20 that act as two-step buffer areas, negative pressure fluctuation is suppressed in a stepwise manner.

Accordingly, the gun microphone wind shield 100 has the first space SP10 and the second space SP20 as described above to make air less likely to leak to the gun microphone 300 and prevent wind noise generated from the diaphragm vibrated by the air.

Further, even in the case where the air does not enter the gun microphone 300, the air may flow around the gun microphone 300 to generate negative pressure fluctuation that vibrates the diaphragm. In such a case, the formation of the first space SP10 and the second space SP20 makes it possible to suppress negative pressure fluctuation and prevent the occurrence of wind noise due to the negative pressure fluctuation.

In this way, the first space SP10 and the second space SP20 can not only shut off the movement of the air but also suppress the occurrence of negative pressure fluctuation.

### Grip Vibration-Proof Structure 400

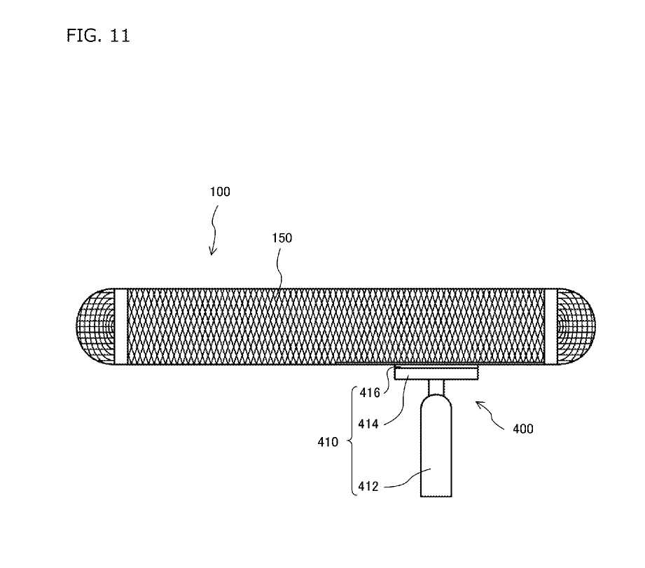

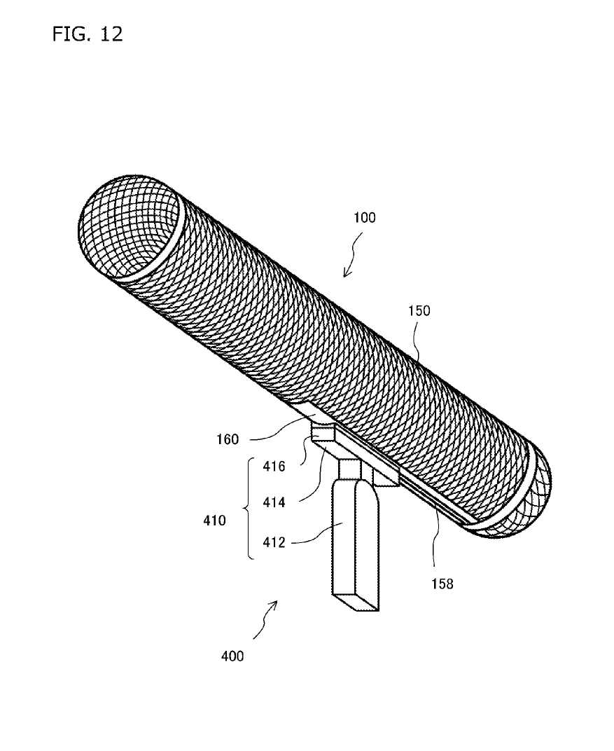

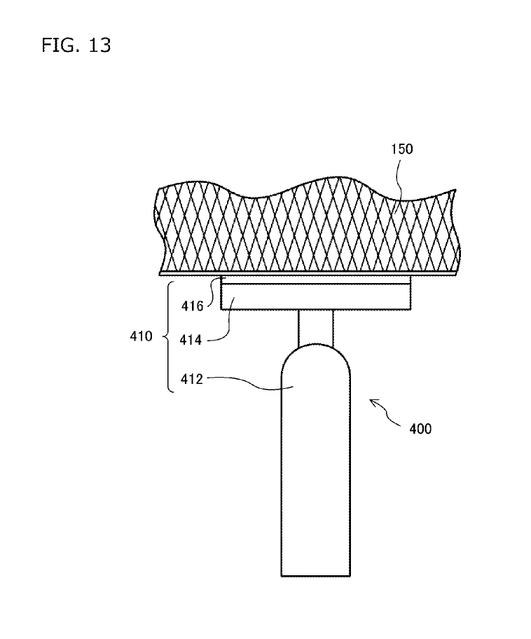

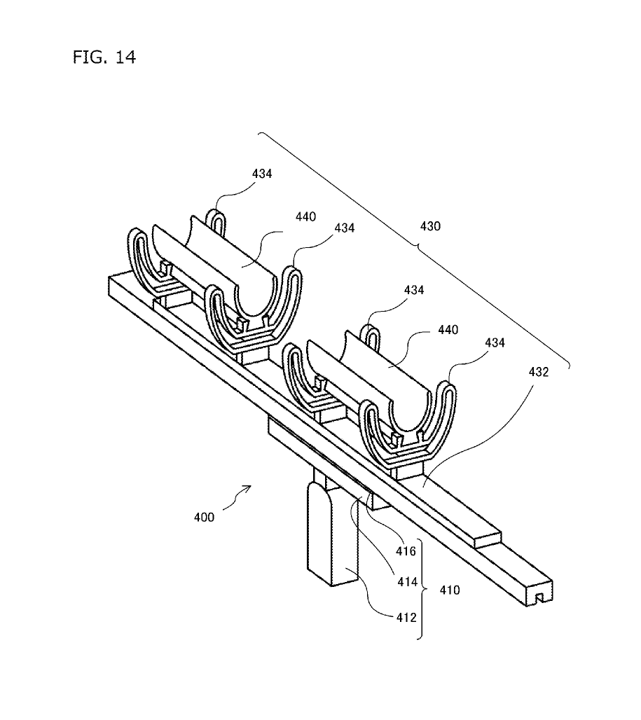

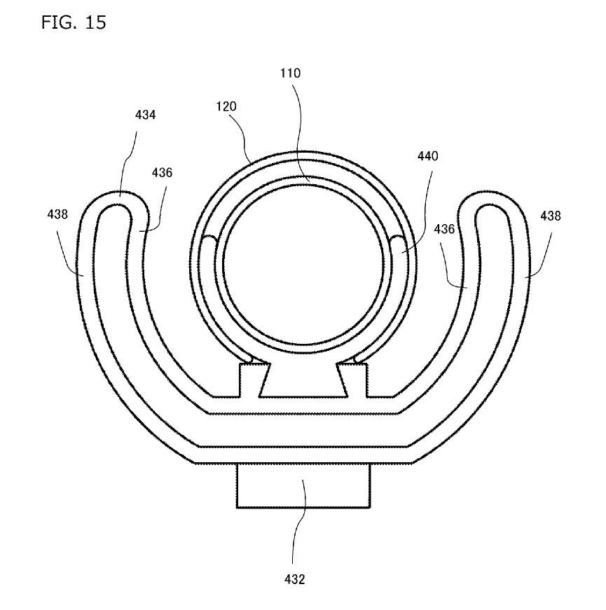

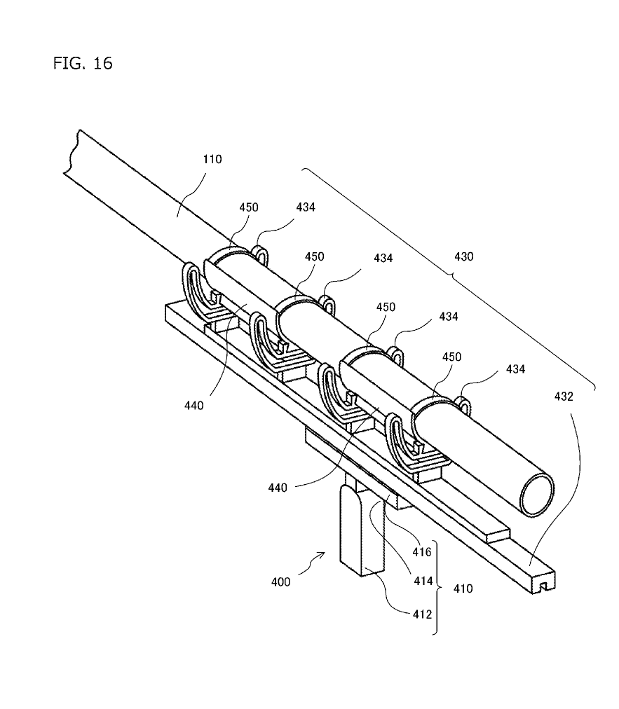

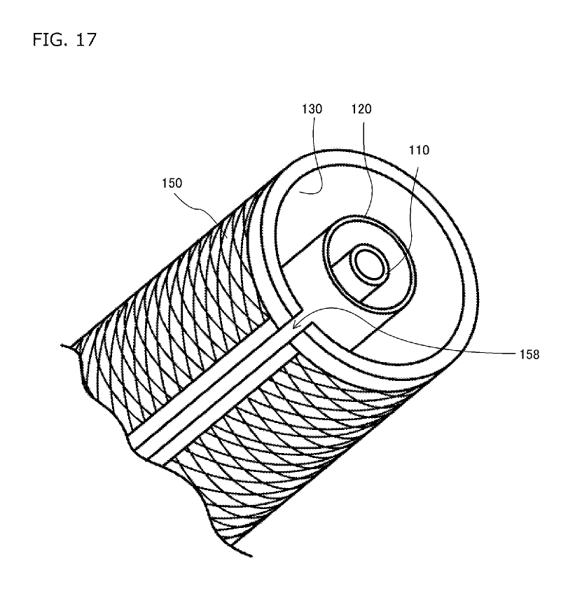

FIG. 11 is a side view of the basket 150 and the grip vibration-proof structure 400. FIG. 12 is a perspective view of the basket 150 and the grip vibration-proof structure 400. FIG. 13 is an enlarged side view of structure of the grip portion 410. FIG. 14 is a perspective view of the entire grip vibration-proof structure 400. FIG. 15 is a front view of the first acoustic transmissive body 110 and the second acoustic transmissive body 120 attached to the elastic hold body 434. FIG. 16 is a perspective view of the first acoustic transmissive body 110 attached to the elastic hold body 434. FIG. 17 is a perspective view of the end of the basket 150.

The grip vibration-proof structure 400 can be detachably attached to the basket 150 of the gun microphone wind shield 100. The grip vibration-proof structure 400 includes a grip portion 410 and a hold portion 430.

The user can hold and support the grip portion 410 with his/her hand to direct the gun microphone 300 with the gun microphone wind shield 100 to a desired sound source. The user can hold indirectly the gun microphone 300 via the gun microphone wind shield 100 due to the grip portion 410 and prevent shock and solid-borne sounds generated during use from being directly transferred to the gun microphone 300.

The hold portion 430 of the grip vibration-proof structure 400 attenuates shock and solid-borne sounds applied to the gun microphone wind shield 100. This prevents the shock and solid-borne sounds from being picked up as noise by the gun microphone 300. The grip vibration-proof structure 400 includes a grip portion 410 and a hold portion 430.

### Slit 158

As illustrated in FIG. 12, the basket 150 has a slit 158 along the longitudinal direction of the basket 150. The slit 158 is formed to extend from the second end 156b of the basket 150 to a retainment position 160 in the middle of the basket 150. Attaching the grip portion 410 and the hold portion 430 to sandwich the basket 150 via the slit 158 allows the grip vibration-proof structure 400 to be detachably attached to the basket 150.

### Grip Portion 410

The grip portion 410 mainly has a grip 412, a coupling body 414, and a vibration absorber 416. The grip 412 and the coupling body 414 are arranged outside the basket 150 while the grip vibration-proof structure 400 is attached to the basket 150.

The grip 412 is a member that can be handheld by the user of the gun microphone 300 and the gun microphone wind shield 100. The user can handhold the grip 412 to direct the gun microphone 300 and the gun microphone wind shield 100 to a desired direction.

The grip 412 is rotatably provided on the coupling body 414. For example, the grip 412 is rotatably attached to the coupling body 414 via a retainment member such as a bolt and a nut. Attaching rotatably the grip 412 to the coupling body 414 allows the user to set the desired angle formed between the grip 412 and the gun microphone 300 having the gun microphone wind shield 100 and to direct the gun microphone 300 to a sound source at a high position or a low position.

The coupling body 414 has an elongated shape and can be attached to the outer surface of the basket 150 along the longitudinal direction. As described later, the coupling body 414 can be attached to a coupling support body 432 of the hold portion 430.

The vibration absorber 416 is made from an elastically deformable resin such as rubber. The vibration absorber 416 has an elongated and plate-like shape. The vibration absorber 416 is sandwiched between the coupling body 414 and the outer surface of the basket 150, in contact with the basket 150. The vibration absorber 416 absorbs a certain degree of shock and solid-borne sounds to make the shock and solid-borne sounds less likely to transfer to the hold portion 430.

### Hold Portion 430

The hold portion 430 mainly has the coupling support body 432, the elastic hold bodies 434, and the brackets 440. The coupling support body 432, the elastic hold bodies 434, and the brackets 440 are arranged inside the basket 150 while the grip vibration-proof structure 400 is attached to the basket 150.

The coupling support body 432 has an elongated shape and can be attached to the inner surface of the basket 150 along the longitudinal direction. The coupling body 414 of the grip portion 410 is arranged on the outer surface of the basket 150 along the longitudinal direction, and the coupling support body 432 is arranged on the inner surface of the basket 150 along the longitudinal direction. The coupling body 414 and the coupling support body 432 are opposed to each other via the slit 158. The coupling body 414 has a plurality of openings (not illustrated), and the coupling support body 432 has a plurality of screw holes (not illustrated) corresponding to the openings in the coupling body 414. Fastening screws (not illustrated) into the screw holes in the coupling support body 432 via the openings in the coupling body 414 allows the hold portion 430 to be detachably attached to the grip portion 410 and allows the grip vibration-proof structure 400 to be detachably provided on the basket 150.

The elastic hold bodies 434 are attached to the coupling support body 432. Each of the elastic hold bodies 434 has an inner arc body 436 and an outer arc body 438. The radius of the inner arc body 436 is smaller than the radius of the outer arc body 438, and the elastic hold bodies 434 have a shape in which the inner arc body 436 and the outer arc body 438 are coupled together. The outer arc body 438 is attached to the coupling support body 432. The inner arc body 436 is attached to the brackets 440 described later.

The inner arc body 436 and the outer arc body 438 are both made of an elastically deformable resin. The inner arc body 436 and the outer arc body 438 elastically deform to absorb external shock and solid-borne sounds, make the shock and solid-borne sounds less likely to transfer to the gun microphone 300, and prevent the shock and solid-borne sounds from being picked up as noise. The function of the elastic hold bodies 434 will be described later.

The brackets 440 are attached to the inner arc body 436. Each of the brackets 440 has an elongate and almost cylindrical shape with a slit on the side surface.

The first acoustic transmissive body 110 is attached to the insides of the brackets 440, and the second acoustic transmissive body 120 is attached to the outsides of the brackets 440. Attaching the first acoustic transmissive body 110 and the second acoustic transmissive body 120 to the brackets 440 makes it possible to keep the first acoustic transmissive body 110 and the second acoustic transmissive body 120 in a constant shape.

In addition, attaching the first acoustic transmissive body 110 and the second acoustic transmissive body 120 with the brackets 440 therebetween makes it possible to form the first space SP1 stably between the first acoustic transmissive body 110 and the second acoustic transmissive body 120 and keep the volume of the first space SP1 constant.

As described above, the first acoustic transmissive body 110 has an elongated and almost cylindrical shape. A ring 450 is provided at a plurality of places on the outside of the first acoustic transmissive body 110 along the longitudinal direction. The rings 450 can prevent the first acoustic transmissive body 110 from being deformed and narrowed. In addition, applying an adhesive to the insides of the rings 450 makes it possible to prevent the first acoustic transmissive body 110 from being displaced in the longitudinal direction. Providing the plurality of rings 450 makes it possible to keep the shape of the first acoustic transmissive body 110 constant and hold the gun microphone 300 stably and allow the gun microphone 300 to be easily detached. Other rings (not illustrated) may be provided inside the first acoustic transmissive body 110 to support the first acoustic transmissive body 110 so that it is possible to prevent the first acoustic transmissive body 110 from being deformed and narrowed without having to apply an adhesive to the insides of the rings 450.

Each of the rings 450 has an opening (not illustrated) via which sounds can be transmitted. As described above, the gun microphone 300 is arranged inside the first acoustic transmissive body 110. Using the rings 450 with openings makes it possible to maintain the sound transmissivity of the first acoustic transmissive body 110.

### Shock Applied to the Gun Microphone Wind Shield 100

As described above, each of the elastic hold bodies 434 has the inner arc body 436 and the outer arc body 438. The inner arc body 436 and the outer arc body 438 elastically deform according to applied force. When the grip 412 is grasped by the operator to change the orientation of the gun microphone 300 or switch the gun microphone 300 from one hand to the other, some shock may be applied to the grip 412. In addition, solid-borne sounds generated by wind and propagated as vibration through a solid body are picked up as wind noise.

The gun microphone wind shield 100 has the vibration absorber 416 and the elastic hold bodies 434 so that shock and solid-borne sounds are attenuated by the vibration absorber 416 and the elastic hold bodies 434 so as not to transfer to the gun microphone 300. The functions of the vibration absorber 416 and the elastic hold bodies 434 will be described below.

### Function of the Vibration Absorber 416

The vibration absorber 416 is formed from a resin such as rubber and is elastically deformable. The vibration absorber 416 is sandwiched between the coupling body 414 and the outer surface of the basket 150, in contact with the basket 150. The shock and solid-borne sounds applied to the grip 412 are attenuated and gradually absorbed by the vibration absorber 416 repeating elastic deformation. Absorbing the shock and solid-borne sounds by the vibration absorber 416 makes the shock and solid-borne sounds less likely to transfer to the hold portion 430.

### Function of the Elastic Hold Bodies 434

Each of the elastic hold bodies 434 has the inner arc body 436 and the outer arc body 438. The inner arc body 436 and the outer arc body 438 elastically deform according to applied force. When the grip 412 is grasped by the operator to change the orientation of the gun microphone 300 or switch the gun microphone 300 from one hand to the other, some shock may be applied to the grip 412. In addition, solid-borne sounds may be applied to the grip 412.

The inner arc bodies 436 and the outer arc bodies 438 are constituted by a resin and are elastically deformable. The shock and solid-borne sounds transferred via the coupling support body 432 are first transferred to the outer arc bodies 438. The outer arc bodies 438 elastically deform due to the shock to attenuate gradually the shock. Similarly, when shock is transferred from the outer arc bodies 438 to the inner arc bodies 436, the inner arc bodies 436 elastically deform due to the shock to attenuate gradually the shock. Even when shock is transferred to the elastic hold bodies 434 via the coupling support body 432, the inner arc bodies 436 and the outer arc bodies 438 prevent the shock from being transferred to the brackets 440 so that the shock is not picked up as noise by the gun microphone. In addition, while solid-borne sounds are transferred as vibration to the outer arc bodies 438 and the inner arc bodies 436, vibration energy is gradually absorbed and attenuated by the outer arc bodies 438 and the inner arc bodies 436.

### Second Embodiment

In the gun microphone wind shield 100 of the first embodiment, the elastic foaming body 140 is provided in the second space SP20. In a second embodiment, the elastic foaming body 140 may not be provided in the second space SP20.

### Gun Microphone Wind Shield 200

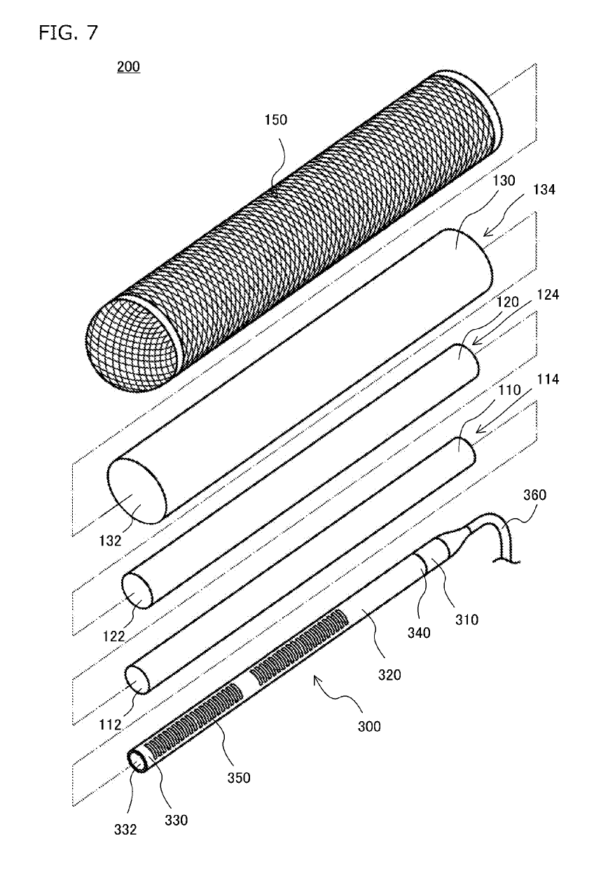

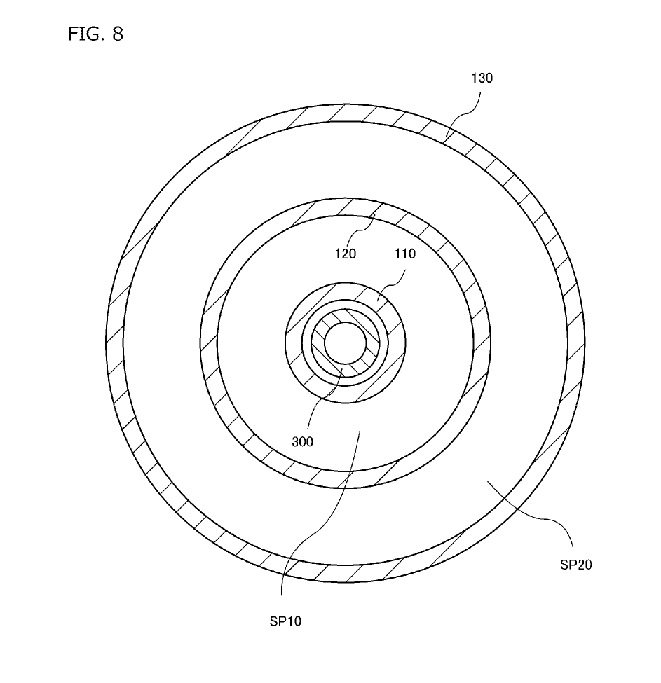

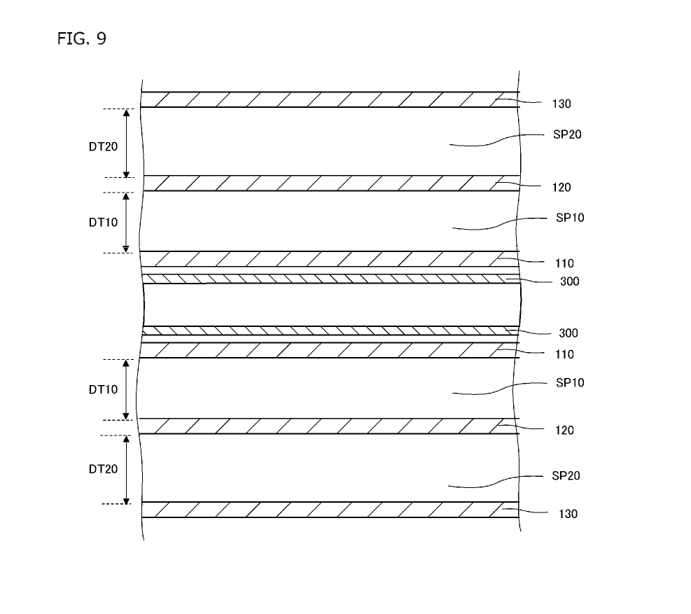

As illustrated in FIGS. 7, 8, and 9, in a gun microphone wind shield 200 of the second embodiment, the elastic foaming body 140 is not provided in the first space SP10 or the second space SP20. The configuration of the gun microphone wind shield 200 in the second embodiment and the configuration of the gun microphone wind shield 100 in the first embodiment are different in the presence or absence of the elastic foaming body 140. That is, a first acoustic transmissive body 110, a second acoustic transmissive body 120, a third acoustic transmissive body 130, and a basket 150 have shapes, materials, and functions similar to those of the first embodiment, and are arranged in manners similar to those of the first embodiment, and are given the same reference signs as those of the first embodiment.

Like the gun microphone wind shield 100 in the first embodiment, a first space SP10 is defined in a region sandwiched between the first acoustic transmissive body 110 and the second acoustic transmissive body 120. A second space SP20 is defined in a region sandwiched between the second acoustic transmissive body 120 and the third acoustic transmissive body 130.

A distance DT10 between the first acoustic transmissive body 110 and the second acoustic transmissive body 120 and a distance DT20 between the second acoustic transmissive body 120 and the third acoustic transmissive body 130 can be decided as appropriate according to the presence or absence of the elastic foaming body 140.

In the gun microphone wind shield 200 of the second embodiment as well as the gun microphone wind shield 100 of the first embodiment, the air having entered the first space SP10 has a component LP10 that moves along the longitudinal direction (see FIGS. 6A and 10) and a component AP10 that moves long the circumferential direction (see FIGS. 6B and 10), and the air having entered the second space SP20 has a component LP20 that moves along the longitudinal direction (see FIGS. 6A and 10) and a component AP20 that moves long the circumferential direction (see FIGS. 6B and 10).

Setting appropriately the distance of the first space SP10 and the distance of the second space SP20 makes it possible to produce the component LP10 moving along the longitudinal direction, the component AP10 moving along the circumferential direction, the component LP20 moving along the longitudinal direction, and the component AP20 moving along the circumferential direction, which makes the air less likely to enter the gun microphone 300, thereby shutting off whistling sounds properly.

### Modification Examples

In the first embodiment, the elastic foaming body 140 is provided only in the second space SP20, and the elastic foaming body 140 is not provided in the first space SP10. In the second embodiment, the elastic foaming body 140 is not provided in the first space SP10 or the second space SP20.

Besides, the elastic foaming body 140 may be provided only in the first space SP10 but may not be provided in the second space SP20, or the elastic foaming body 140 may be provided both in the first space SP10 and the second space SP20.

In either case, setting appropriately the distance of the first space SP10 and the distance of the second space SP20 according to the presence or absence of the elastic foaming body 140 makes it possible to produce the component LP10 moving along the longitudinal direction, the component AP10 moving along the circumferential direction, the component LP20 moving along the longitudinal direction, and the component AP20 moving along the circumferential direction, which makes the air less likely to enter the gun microphone 300, thereby shutting off whistling sounds properly.

### REFERENCE SIGNS LIST

100 Gun microphone wind shield
110 First acoustic transmissive body
120 Second acoustic transmissive body
130 Third acoustic transmissive body
140 Elastic foaming body
150 Basket
300 Gun microphone
SP10 First space
SP20 Second space

1. A gun microphone wind shield comprising:
a first covering body that covers a gun microphone, has an elongated shape, and contains an acoustic transmissive material;
a second covering body that covers the first covering body, is arranged in a position separated from the first covering body, has an elongated shape, contains an acoustic transmissive material, and defines a first space between the second covering body and the first covering body; and
a third covering body that covers the second covering body, is arranged in a position separated from the second covering body, has an elongated shape, contains an acoustic transmissive material, and defines a second space between the third covering body and the second covering body, wherein
the acoustic transmissive material contains a fiber material obtained by interlacing a raw material containing fibers, blocks part of air in contact, and transmits the remainder of the air,
the second space has a second longitudinal flow path in which air having flowed into the second space moves along a longitudinal direction of the second covering body, and
the first space has a first longitudinal flow path in which air having flowed into the first space moves along a longitudinal direction of the first covering body.

2. The gun microphone wind shield according to claim 1, wherein an elastic foaming body with open cells is provided in at least part of the first space or the second space.

3. The gun microphone wind shield according to claim 1, wherein the second space has a second circular flow path in which the air having passed through the third covering body and flowed into the second space moves along at least part of the circumference of the second covering body.

4. The gun microphone wind shield according to claim 1, wherein the first space has a first circular flow path in which the air having passed through the second covering body and flowed into the first space moves along at least part of the circumference of the first covering body.

5. The gun microphone wind shield according to claim 1, wherein longitudinal lengths of the first covering body and the second covering body are larger than the distance of the first space or the distance of the second space.
